(19) United States
(12) Patent Application Publication
(10) Pub. No.: US 2024/0063666 A1
(43) Pub. Date: Feb. 22, 2024

(54) STATOR, ROTARY ELECTRIC MACHINE, METHOD FOR MANUFACTURING STATOR, AND METHOD FOR MANUFACTURING ROTARY ELECTRIC MACHINE

(71) Applicant: Mitsubishi Electric Corporation, Chiyoda-ku, Tokyo (JP)

(72) Inventors: Takayuki ONIHASHI, Chiyoda-ku, Tokyo (JP); Takeshi YAGI, Chiyoda-ku, Tokyo (JP); Ryo NABIKA, Chiyoda-ku, Tokyo (JP); Hiroki DAITO, Chiyoda-ku, Tokyo (JP); Taichi TOKUHISA, Chiyoda-ku, Tokyo (JP); Tomoya ITOSE, Chiyoda-ku, Tokyo (JP)

(73) Assignee: Mitsubishi Electric Corporation, Chiyoda-ku, Tokyo (JP)

(21) Appl. No.: 18/260,664

(22) PCT Filed: Nov. 22, 2021
(86) PCT No.: PCT/JP2021/042814

§ 371 Date: Jul. 7, 2023

(30) Foreign Application Priority Data
Apr. 5, 2021 (JP) 2021-063930

(51) Int. Cl. H02K 1/14; H02K 3/28; H02K 3/52; H02K 15/02; H02K 15/00

(52) U.S. Cl. CPC H02K 1/148; H02K 3/28; H02K 3/522; H02K 15/022; H02K 15/0068; H02K 2203/12

(57) ABSTRACT

Magnetic-pole pieces each equipped with a pair of insulators made of resin are provided with a conductive wire wound continuously via a jumper wire making connection between the magnetic-pole pieces, and are arranged in an annular shape. Each insulator has, at one end in a circumferential direction of an axial-direction end, a snap-fit female portion having an opened-ring portion having an opening, and has, at another end, a snap-fit male portion having a pillar portion extending in the axial direction from a base portion. The adjacent magnetic-pole pieces are connected swingably relative to each other via snap-fit connection by fitting of the pillar portion to the opened-ring portion. A jumper-wire-caught portion at which a jumper wire is caught is provided at least in one location of the connection part where mutual connection is made.

### TECHNICAL FIELD

The present disclosure relates to a stator, a rotary electric machine, a stator manufacturing method, and a rotary electric machine manufacturing method.

### BACKGROUND ART

Regarding a stator of a rotary electric machine, it is disclosed that magnetic-pole pieces obtained by dividing a core on a tooth basis are connected via insulators so as to be bendable in a direction perpendicular to a rotation output shaft direction (hereinafter, simply referred to as axial direction) (see, for example, Patent Document 1 below).

With this configuration, in order to wind a wire around a tooth portion of the magnetic-pole piece, the angle of a connection part between the insulators is changed so that the tooth portions are located on the radially outer side, whereby the conductive wire can be wound around the tooth portion without interference between the adjacent magnetic-pole pieces. Thus, the space factor of the winding can be improved.

### CITATION LIST

### Patent Document

Patent Document 1: Japanese Laid-Open Patent Publication No. 2006-254569

### SUMMARY OF THE INVENTION

### Problem to be Solved by the Invention

However, in Patent Document 1, in order to connect the adjacent magnetic-pole pieces using the insulators, two kinds of insulators having different shapes need to be prepared. Thus, there is a problem that the number of kinds of members increases and a process is complicated.

In addition, for connection and rotation of the magnetic-pole pieces, a mechanism of extraction/insertion in the axial direction is provided. Then, at the time of placing the tooth portions on the radially outer side in order to wind a wire around the tooth portion of the magnetic-pole piece, a retention mechanism and the like need to be prepared for preventing the magnetic-pole pieces from being displaced in the axial direction after connection. Thus, there is a problem that the manufacturing process is complicated.

In addition, in a case of performing winding around a plurality of magnetic-pole pieces via jumper wires, when the tooth portions of the magnetic-pole pieces are arranged on the radially inner side so as to be an annular shape, the jumper wires move and it is difficult to fix and place them at constant positions. Thus, it might be necessary to separately perform a process of fixing and placing the jumper wires at predetermined positions.

The present disclosure has been made to solve the above problems, and an object of the present disclosure is to provide a stator, a rotary electric machine, a stator manufacturing method, and a rotary electric machine manufacturing method for obtaining a high-performance product at low cost without increasing the number of components and the number of manufacturing steps.

### Means to Solve the Problem

A stator according to the present disclosure includes a plurality of magnetic-pole pieces in each of which a tooth portion is integrally formed so as to protrude from an arc-shaped back yoke portion inward in a radial direction. A pair of insulators made of resin are attached to each magnetic-pole piece, in an axial direction perpendicular to the radial direction. The magnetic-pole pieces with the insulators attached thereto are arranged in an annular shape in a state in which a conductive wire is continuously wound via a jumper wire making connection between the magnetic-pole pieces. Each insulator has a snap-fit female portion at one end in a circumferential direction of an axial-direction end thereof and has a snap-fit male portion at another end. The snap-fit female portion has an opened-ring portion having an opening that opens in a direction perpendicular to the axial direction. The snap-fit male portion has a pillar portion extending in the axial direction from a base portion protruding in the circumferential direction and the radial direction. The adjacent magnetic-pole pieces in the annular-shape arrangement are connected swingably relative to each other via snap-fit connection made by fitting of the pillar portion to the opened-ring portion. A jumper-wire-caught portion at which the jumper wire is caught is provided at least in one location of a connection part where mutual connection is made by the snap-fit connection.

A rotary electric machine according to the present disclosure includes: the stator having the above configuration; and a rotor provided rotatably and coaxially on an inner circumferential surface side of the stator.

A stator manufacturing method according to the present disclosure includes: an insulation assembly step of attaching the insulators to each magnetic-pole piece; a wiring step of repeating a winding step of winding, in a concentrated manner, the conductive wire around one magnetic-pole piece having undergone the insulation assembly step, and a jumper wire step of, after the winding step, leading the conductive wire as the jumper wire to the magnetic-pole piece that is a next winding target without cutting the conductive wire; and an annular shaping step of, after winding of the conductive wire is completed for all the magnetic-pole pieces in the wiring step, arranging the magnetic-pole pieces in the annular shape and connecting all the adjacent magnetic-pole pieces by the snap-fit connection of the insulators.

A rotary electric machine manufacturing method according to the present disclosure includes a step of providing a rotor rotatably and coaxially on a radially inner side of the stator, after a process of the stator manufacturing method.

### Effect of the Invention

The stator, the rotary electric machine, the stator manufacturing method, and the rotary electric machine manufacturing method according to the present disclosure make it possible to obtain a small-sized and high-performance product at low cost without increasing the number of components. In addition, with the stator manufacturing method and the rotary electric machine manufacturing method according to the present disclosure, manufacturing can be performed without increasing the number of manufacturing steps, whereby the manufacturing cost can be reduced.

### BRIEF DESCRIPTION OF THE DRAWINGS

FIG. 1 is a schematic sectional view showing a stator of a rotary electric machine according to embodiment 1.

FIG. 2 is a perspective view showing one magnetic-pole piece composing the stator according to embodiment 1.

FIG. 3 is a wire-connection diagram showing the wire-connection state of magnetic-pole pieces of the stator according to embodiment 1.

FIG. 4 is a wire-connection diagram schematically showing the wire-connection state when all the magnetic-pole pieces composing the stator according to embodiment 1 are arranged in a straight shape.

FIG. 5 is a perspective view showing a state in which two insulators are attached to the magnetic-pole piece as seen from the radially inner side of the stator in embodiment 1.

FIG. 6 is a front view showing a state in which two insulators are attached to the magnetic-pole piece as seen from the radially outer side of the stator in embodiment 1.

FIG. 7 is a perspective view of one insulator to be attached to the magnetic-pole piece as seen from the radially inner side in embodiment 1.

FIG. 8 is a perspective view of the insulator as seen from the radially outer side in embodiment 1.

FIG. 9 is a plan view showing a state in which two adjacent magnetic-pole pieces with the insulators attached thereto are connected by snap-fit and arranged in a straight shape in embodiment 1.

FIG. 10 is a perspective view showing a state in which the magnetic-pole pieces with the configuration shown in FIG. 8 are arranged so as to be bent in a V shape.

FIG. 11 is a schematic configuration diagram of an automatic winding machine used when manufacturing the stator of the rotary electric machine in embodiment 1.

FIG. 12 illustrates a state in which a conductive wire is wound continuously over four magnetic-pole pieces corresponding to one phase (here, V phase) of three-phase AC, in embodiment 1.

FIG. 13 illustrates a state in which a conductive wire is wound continuously over four magnetic-pole pieces corresponding to another phase (here, U phase) of the three-phase AC, in embodiment 1.

FIG. 14 is a schematic side view showing arrangement when a jumper wire is provided in a state in which adjacent magnetic-pole pieces are connected by snap-fit connection of the insulators, as seen in the circumferential direction, in embodiment 1.

FIG. 15 is a schematic half sectional view showing an example for assuredly fixing the jumper wire to the magnetic-pole piece in the stator of embodiment 1.

FIG. 16 is a flowchart showing a stator manufacturing method of embodiment 1.

FIG. 17 is another flowchart showing the stator manufacturing method of embodiment 1.

FIG. 18A is a schematic sectional view of a rotary electric machine obtained by the stator manufacturing method according to embodiment 1, and FIG. 18B is an enlarged view of part A1 in FIG. 18A.

FIG. 19 is a perspective view of one insulator to be attached to a magnetic-pole piece as seen from the radially inner side in embodiment 2.

FIG. 20 is a perspective view of the insulator as seen from the radially outer side in embodiment 2.

FIG. 21 is a schematic side view showing arrangement when a jumper wire is provided in a state in which the insulators are attached to the adjacent magnetic-pole pieces, as seen in the circumferential direction, in embodiment 2.

FIG. 22 illustrates a state in which a conductive wire is wound continuously over four magnetic-pole pieces corresponding to one phase (here, V phase) of the three-phase AC, in embodiment 2.

FIG. 23 illustrates a state in which a conductive wire is wound continuously over four magnetic-pole pieces corresponding to one phase (here, U phase) of the three-phase AC, in embodiment 2.

FIG. 24 is a perspective view of one insulator to be mounted to a magnetic-pole piece as seen from the radially inner side in embodiment 3.

FIG. 25 is a perspective view of the insulator as seen from the radially outer side in embodiment 3.

FIG. 26 is a schematic side view showing arrangement when a jumper wire is provided in a state in which the insulators are attached to the adjacent magnetic-pole pieces, as seen in the circumferential direction, in embodiment 3.

FIG. 27 is a schematic side view showing a modification of the insulator in embodiment 3.

FIG. 28 is a schematic side view showing a modification of an insulator.

FIG. 29 is a schematic side view showing a modification of an insulator.

FIG. 30 is a schematic side view showing a modification of an insulator.

FIG. 31 is a schematic side view showing a modification of an insulator.

FIG. 32 is a schematic sectional view of a rotary electric machine according to a modification of embodiment 1.

FIG. 33 is a schematic sectional view of a rotary electric machine according to another modification of embodiment 1.

FIG. 34 is a schematic side view showing another modification of the insulator in embodiment 3.

FIG. 35 is a schematic side view showing still another modification of the insulator in embodiment 3.

### DESCRIPTION OF EMBODIMENTS

### Embodiment 1

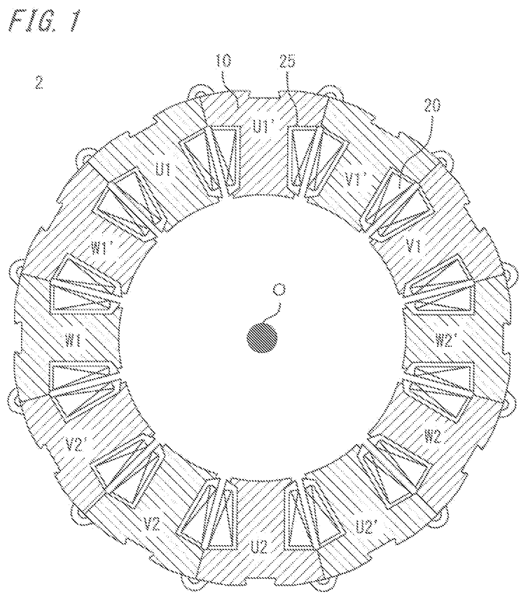

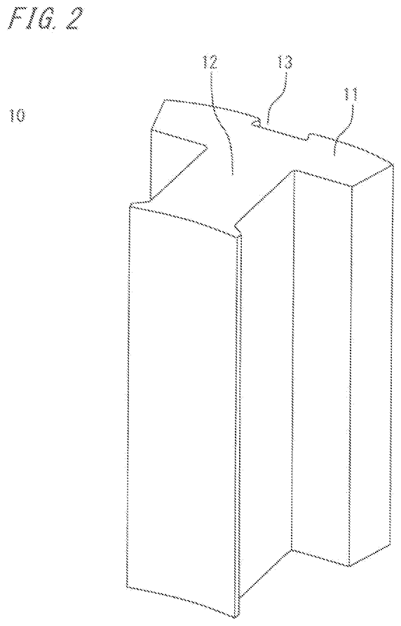

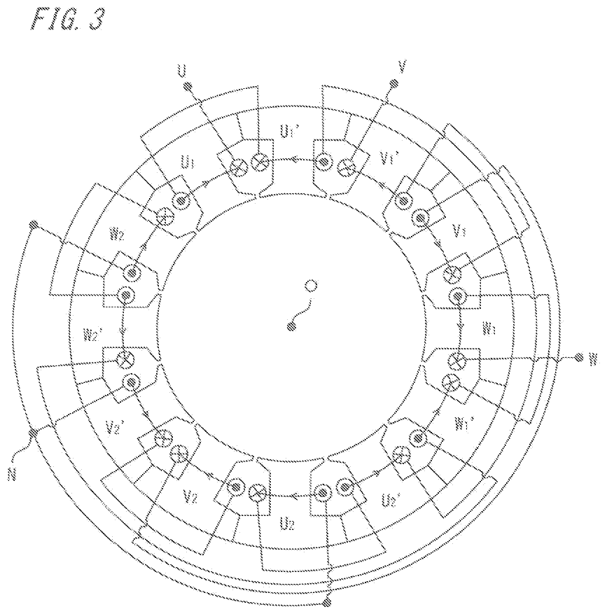

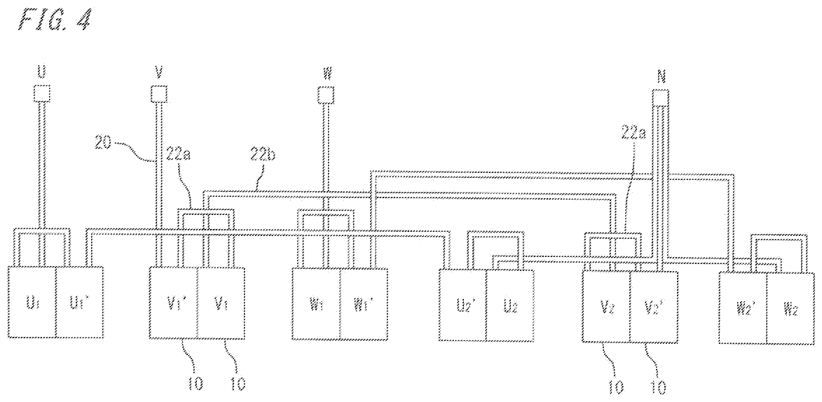

FIG. 1 is a schematic sectional view showing a stator of a rotary electric machine of embodiment 1, FIG. 2 is a perspective view showing one magnetic-pole piece composing the stator of embodiment 1, FIG. 3 is a wire-connection diagram showing the wire-connection state of magnetic-pole pieces composing the stator of embodiment 1, and FIG. 4 is a wire-connection diagram schematically showing the wire-connection state when all the magnetic-pole pieces composing the stator of embodiment 1 are arranged in a straight shape. In FIG. 4, the magnetic-pole pieces are shown in a simplified manner, and insulators and conductive wires wound around tooth portions are not shown.

A rotary electric machine 1 of embodiment 1 is for a three-phase DC brushless motor having 10 poles and 12 teeth, as an example, and includes a plurality of (in this example, 12) magnetic-pole pieces 10 which are stacked cores each formed by stacking a plurality of thin sheets along the axial direction and fixing them by swaging, welding, or the like.

Each magnetic-pole piece 10 includes a back yoke portion 11 and a tooth portion 12 protruding radially inward from the back yoke portion 11. The back yoke portion 11 has, on the radially-outer circumferential surface side, an attachment groove 13 for attaching the magnetic-pole piece 10 to a retention jig 52 of a rotational-positioning mechanism 51 described later in manufacturing of the stator 2.

Insulators 25 having the same shape are attached to each magnetic-pole piece 10 from both ends in the axial direction. The details of the structure of the insulator 25 will be described later. Two adjacent magnetic-pole pieces 10 with the insulators 25 attached thereto are regarded as a set, and a conductive wire 20 formed from a copper wire or the like is wound on the insulators 25 continuously over two sets (four in total) of magnetic-pole pieces 10. The total of four magnetic-pole pieces 10 composed of sets of two magnetic-pole pieces correspond to one phase of U, V, W phases of the three-phase AC.

Among the four magnetic-pole pieces 10 wound with the conductive wire 20, one set of two magnetic-pole pieces 10 and another set of two magnetic-pole pieces 10 are arranged opposite to each other at point-symmetric positions across a circle center O, and sets of two magnetic-pole pieces 10 are sequentially arranged with their phases alternated along the circumferential direction so as to form an annular shape. The circumferential-direction abutting ends of the back yoke portions 11 of the magnetic-pole pieces 10 arranged in an annular shape are connected by later-described snap-fit connection of the insulators 25.

Thus, the stator 2 for a three-phase DC brushless motor having 10 poles and 12 teeth is formed.

In FIG. 1, FIG. 3, and FIG. 4, reference characters U, V, W assigned to the magnetic-pole pieces 10 correspond to the respective phases of the three-phase AC, and N denotes a neutral point. In addition, indices added to each of the phases U, V, W are for discriminating the conductive wires 20 wound around the tooth portions 12 of the two adjacent magnetic-pole pieces 10, and U1 and U1′ respectively represent opposite winding directions for left and right. For example, in FIG. 3, U1 represents left-turn winding and U1′ represents right-turn winding, as seen from the back yoke portion 11 side. As for difference between U1 and U2, U1 represents the conductive wire 20 wound for the first set of the sets of two magnetic-pole pieces 10, and U2 represents the conductive wire 20 wound for the second set of the sets of two magnetic-pole pieces 10.

The conductive wire 20 wound at the tooth portion 12 of each magnetic-pole piece 10 is referred to as a winding 21, and the conductive wire 20 led across between the magnetic-pole pieces 10 without being cut is referred to as a jumper wire 22. In this case, if the jumper wires 22 need to be discriminated in particular, the jumper wire making connection between two magnetic-pole pieces 10 in each set is denoted by 22a, and the jumper wire making connection between the respective sets of two magnetic-pole pieces 10 is denoted by 22b.

In embodiment 1, as shown in FIG. 4, in a case of winding the conductive wire 20 continuously within the same phase, for any of U, V, W phases, four magnetic-pole pieces 10 are regarded as one unit, and in each unit, the conductive wire 20 is wound continuously via the jumper wire 22a making connection between two adjacent magnetic-pole pieces 10 in each set and the jumper wire 22b making connection between the respective sets of two magnetic-pole pieces 10. Therefore, the number of connections of winding terminal portions can be decreased and manufacturing can be performed at low cost, thus having an advantage.

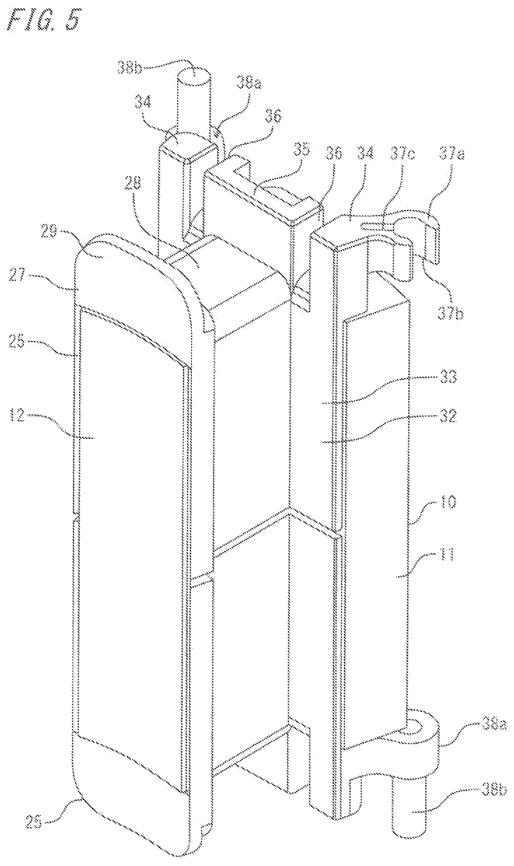

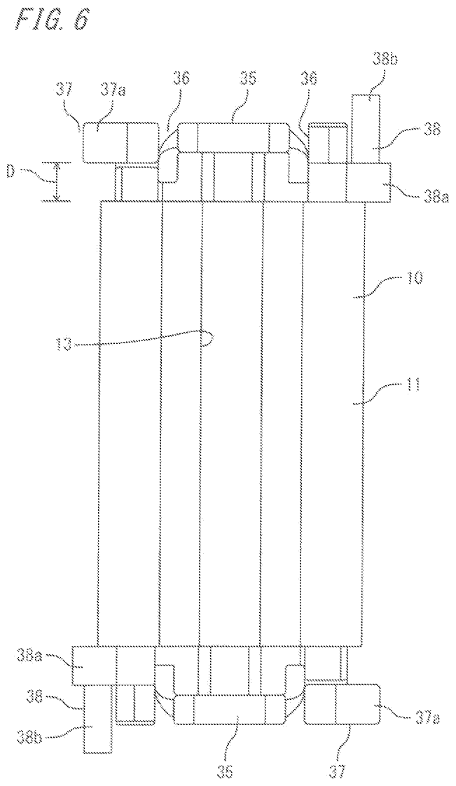

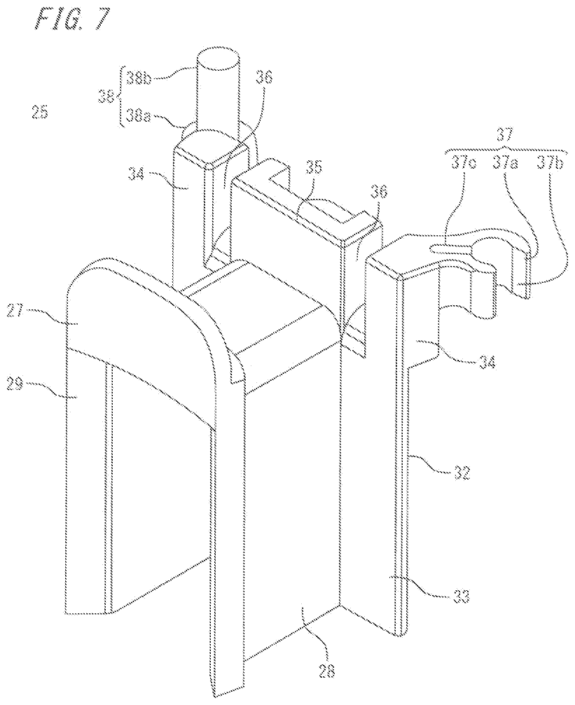

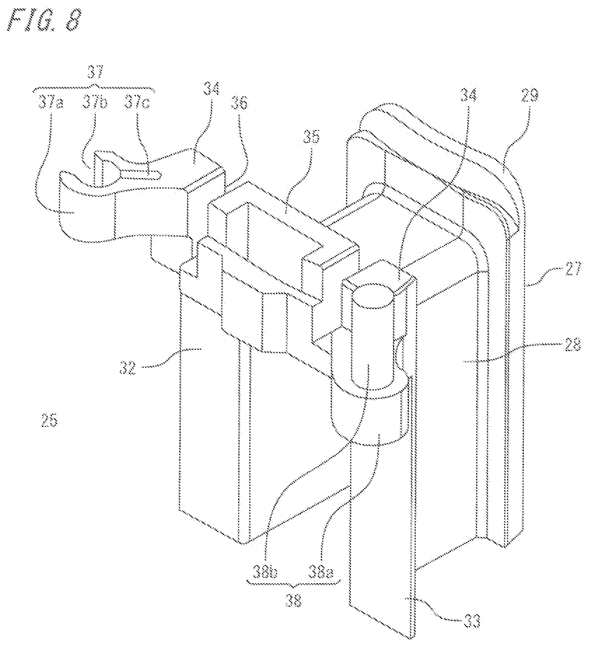

FIG. 5 is a perspective view showing a state in which two insulators are attached to one magnetic-pole piece as seen from the radially inner side of the stator in embodiment 1, and FIG. 6 is a front view showing a state in which two insulators are attached to one magnetic-pole piece as seen from the radially outer side of the stator in embodiment 1. FIG. 7 is a perspective view of the insulator attached to the magnetic-pole piece as seen from the radially inner side in embodiment 1, and FIG. 8 is a perspective view of the insulator as seen from the radially outer side in embodiment 1.

The insulator 25 is integrally molded with insulating thermoplastic resin, for example, and the insulators 25 that are one kind and have the same shape are used for all the magnetic-pole pieces 10. The insulator 25 includes a tooth fitting portion 27 to be fitted to the tooth portion 12 of each magnetic-pole piece 10, and a back yoke fitting portion 32 to be fitted to the back yoke portion 11.

The tooth fitting portion 27 includes a dome-shaped winding portion 28 covering, over a half range in the axial direction, circumferential side surfaces in the circumferential direction of the tooth portion 12 of the magnetic-pole piece 10, and a winding blocking portion 29 protruding in the circumferential direction and the axial direction from the radially inner end of the winding portion 28.

The back yoke fitting portion 32 has inner-circumferential-surface cover portions 33 formed at the left and right sides in the circumferential direction with respect to the winding portion 28 and covering the inner circumferential surface of the back yoke portion 11. Each inner-circumferential-surface cover portion 33 has, at one axial-direction end, a quadrangular-prism-shaped protruding portion 34 protruding in the circumferential direction and the radial direction. An intermediate protruding portion 35 protruding in the axial direction is provided between both protruding portions 34. Winding release grooves 36 are formed between the intermediate protruding portion 35 and the protruding portions 34. Each winding release groove 36 serves for releasing a winding start part and a winding finish part of the conductive wire 20 outward in the radial direction in order to prevent the winding start part and the winding finish part of the conductive wire 20 from interfering with the winding.

An opened-ring portion 37a having substantially a C shape and protruding in the circumferential direction and outward in the radial direction is integrally formed from one protruding portion 34 (right side in FIG. 5 and FIG. 7). The opened-ring portion 37a has an opening 37b that opens in a direction perpendicular to the axial direction, and a cut portion 37c on a side opposed to the opening 37b. The opened-ring portion 37a having the cut portion 37c and the opening 37b forms a snap-fit female portion 37. As shown in FIG. 6, the opened-ring portion 37a is provided such that a gap corresponding to an axial-direction thickness D of a base portion 38a described below is formed between the opened-ring portion 37a and the axial-direction end of the magnetic-pole piece 10.

The base portion 38a protruding in the circumferential direction and outward in the radial direction is integrally formed from the other protruding portion 34 (left side in FIG. 5 and FIG. 7), and a pillar portion 38b having a columnar shape and extending in the axial direction is formed on the base portion 38a. The base portion 38a and the pillar portion 38b form a snap-fit male portion 38.

In this case, the axial-direction thickness D of the base portion 38a of the snap-fit male portion 38 is set so as to correspond to the axial-direction gap of the opened-ring portion 37a of the snap-fit female portion 37 as described above so that the pillar portion 38b is fitted to the inside of the opened-ring portion 37a through the opening 37b when the insulators 25 are arranged adjacently to each other as described later. The axial-direction length of the pillar portion 38b is set to be greater than the axial-direction thickness of the opened-ring portion 37a. The base portion 38a and the pillar portion 38b form the snap-fit male portion 38.

Preferably, the outer diameter of the pillar portion 38b is set to be not less than the inner diameter of the opened-ring portion 37a in a free state in which no external force is applied to the opened-ring portion 37a of the snap-fit female portion 37. This is for preventing the pillar portion 38b from readily coming off the opened-ring portion 37a in a state in which the pillar portion 38b is fitted and connected to the opened-ring portion 37a.

The opening 37b provided to the opened-ring portion 37a of the snap-fit female portion 37 is set to have a slit width not greater than the diameter of the pillar portion 38b in a free state in which no external force is applied. This is also for preventing the pillar portion 38b from readily coming off the opened-ring portion 37a in a state in which the pillar portion 38b is fitted and connected to the opened-ring portion 37a.

The opened-ring portion 37a is provided with the cut portion 37c on the side opposed to the opening 37b. By providing such a cut portion 37c, a force for expanding the opening 37b can be reduced, so that fitting of the pillar portion 38b into the opened-ring portion 37a can be smoothly performed, and also, when a force in a direction from the inner-circumferential-surface side to the outer-circumferential-surface side of the opened-ring portion 37a is accidentally applied, breakage of the opened-ring portion 37a can be prevented.

The insulators 25 configured as described above are used, and with the insulators 25 arranged adjacently to each other as described later, the pillar portion 38b of the snap-fit male portion 38 is inserted into the opening 37b of the opened-ring portion 37a of the snap-fit female portion 37 in a direction perpendicular to the axial direction, whereby a firm connection part by snap-fit connection is formed and the pillar portion 38b is rotatably retained in the opened-ring portion 37a.

The inner circumferential surface of the opened-ring portion 37a does not necessarily need to have an arc shape as long as the pillar portion 38b can rotate. Also, the pillar portion 38b need not have a columnar shape as long as a necessary rotation range can be ensured, and may have various shapes as appropriate, e.g., in a case of desiring to retain the pillar portion 38b at a certain angle, the pillar portion 38b may have an elliptic sectional shape or may be partially cut out.

Next, work for attaching the insulator 25 to one magnetic-pole piece 10 (hereinafter, referred to as insulation assembly work) will be described.

As shown in FIG. 5 and FIG. 6, the insulators 25 shown in FIG. 7 and FIG. 8 are attached to one magnetic-pole piece 10 from both axial-direction ends thereof. At this time, circumferential-direction arrangement of the snap-fit female portion 37 and the snap-fit male portion 38 is reversed between both axial-direction end sides. Thus, circumferential surfaces in the circumferential direction of the tooth portion 12 of the magnetic-pole piece 10 are covered by the winding portions 28 of the insulators 25 which are insulating materials.

The two insulators 25 attached from both axial-direction ends of the magnetic-pole piece 10 have the same shape, as shown in FIG. 7 and FIG. 8. Thus, as compared to a case where the insulators 25 inserted from the front and rear sides in the axial direction have different shapes, the number of kinds of resin-molding molds can be decreased and the products can be provided at low cost.

Here, a pair of insulators 25 are attached to the magnetic-pole piece 10, but instead, the magnetic-pole piece 10 may be put into a molding machine and directly covered by resin, whereby the insulators 25 may be integrally molded.

Next, work in which the magnetic-pole pieces 10 with the insulators 25 attached thereto are connected to each other by snap-fit connection, will be described.

Here, for facilitating understanding, a case of connecting a pair of adjacent magnetic-pole pieces 10 will be described as an example. However, the same applies to a case of connecting three or more magnetic-pole pieces 10.

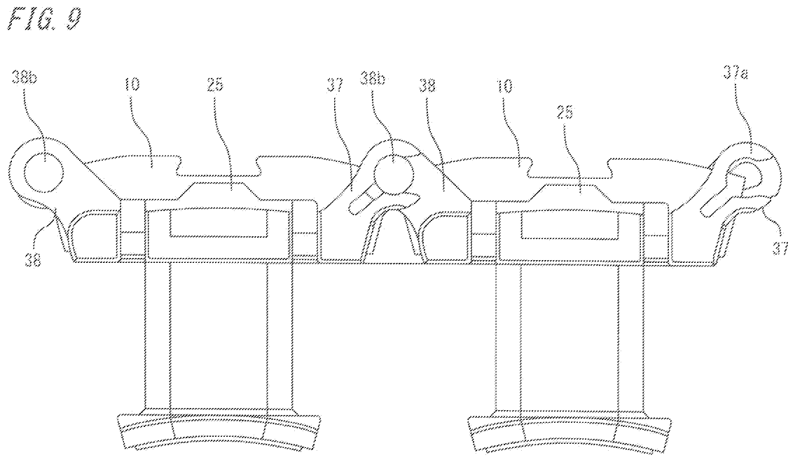

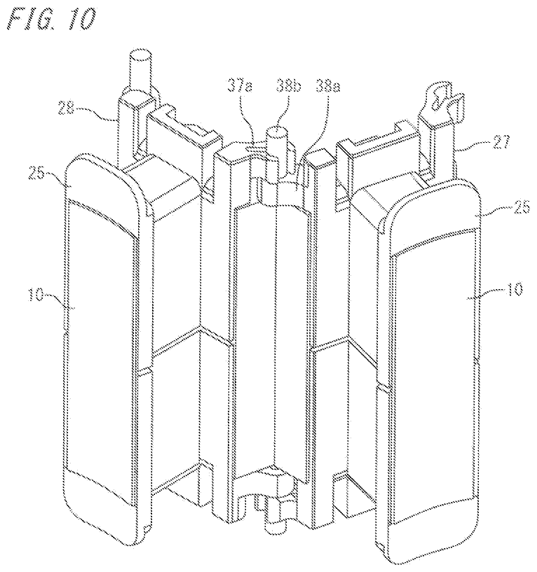

FIG. 9 is a plan view showing a state in which two adjacent magnetic-pole pieces with the insulators attached thereto are connected by snap-fit and arranged in a straight shape, and FIG. 10 is a perspective view showing a state in which the magnetic-pole pieces with the configuration shown in FIG. 9 are arranged so as to be bent in a V shape.

As shown in FIG. 9 and FIG. 10, a pair of magnetic-pole pieces 10 with the insulators 25 attached thereto are arranged side by side such that the back yoke portions 11 thereof are adjacent to each other. Thus, between the adjacent magnetic-pole pieces 10, the pillar portions 38b of the snap-fit male portions 38 are opposed to the openings 37b provided to the opened-ring portions 37a of the snap-fit female portions 37, at both axial-direction ends.

Then, with the angle between the magnetic-pole pieces 10 adjusted, the pillar portions 38b are pushed into the opened-ring portions 37a. Thus, the pair of adjacent magnetic-pole pieces 10 with the insulators 25 attached thereto are snap-fit connected at both axial-direction ends at the same time, so that the adjacent magnetic-pole pieces 10 are connected rotatably relative to each other about the connection part. Connection of the pillar portion 38b and the opened-ring portion 37a can be manually made, but they may be fitted to each other using a jig or the like.

Regarding both adjacent insulators 25 attached to the magnetic-pole pieces 10, as described above, the opened-ring portion 37a of each snap-fit female portion 37 is provided such that a gap corresponding to the thickness D of the base portion 38a of the snap-fit male portion 38 is formed between the opened-ring portion 37a and the end of the magnetic-pole piece 10 in the axial direction.

Thus, when the adjacent magnetic-pole pieces 10 with the insulators 25 attached thereto are connected by snap-fit connection, each base portion 38a is held in the gap D. Therefore, even if movement in the axial direction occurs, the movement is restricted by contact between the opened-ring portion 37a and the base portion 38a. Accordingly, the adjacent magnetic-pole pieces 10 are prevented from coming off due to axial-direction displacement therebetween. As a result, the state in which a plurality of magnetic-pole pieces 10 are connected (see FIG. 9 and FIG. 10) can be easily maintained, and they can be easily connected in an annular shape as shown in FIG. 1. In addition, since the axial-direction length of the pillar portion 38b is set to be greater than the axial-direction thickness of the opened-ring portion 37a, the axial-direction end of the pillar portion 38b protrudes from the opened-ring portion 37a in the axial direction by a certain length L.

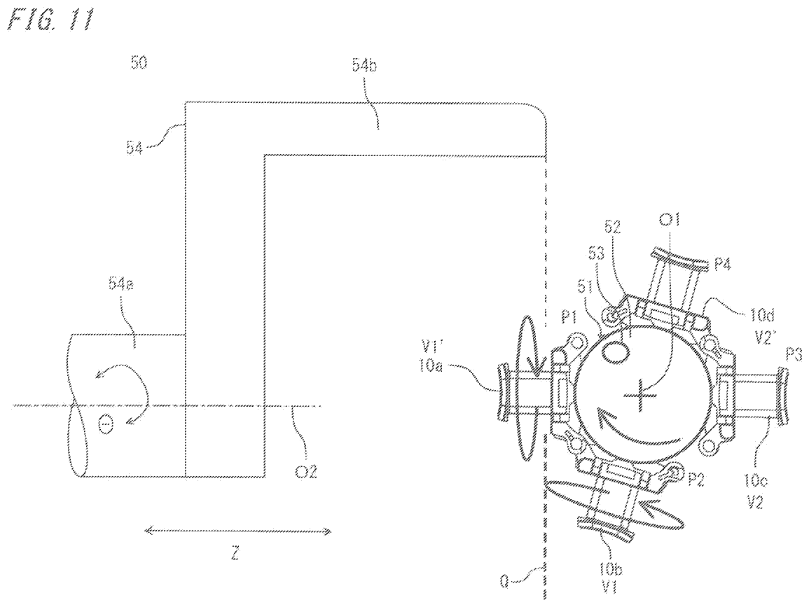

FIG. 11 is a schematic configuration diagram of an automatic winding machine used when forming the stator of the rotary electric machine having the above configuration.

This automatic winding machine 50 includes a rotational-positioning mechanism 51 for positioning each magnetic-pole piece 10, and a flyer 54 for feeding and winding the conductive wire 20. Hereinafter, in a case of performing winding of the conductive wire 20 using the automatic winding machine 50, the magnetic-pole piece 10 with the insulators 25 attached thereto is simply referred to as magnetic-pole piece 10, for convenience of description.

The rotational-positioning mechanism 51 has a disk-shaped retention jig 52 for fixing the magnetic-pole pieces 10. The retention jig 52 is provided with, along the circumferential direction thereof, a plurality of attachment pins (not shown) to be inserted into the attachment grooves 13 formed on the magnetic-pole pieces 10, and a winding-start-wire fixation pin 53 for fixing a winding start part of the conductive wire 20. The retention jig 52 is rotatable about a center O1 thereof as a rotation center.

The flyer 54 is for winding the conductive wire 20 around the tooth portion 12 of each magnetic-pole piece 10 while feeding the conductive wire 20. The flyer 54 is configured such that an arm portion 54b attached to an axial end of the turning shaft 54a is turnable in forward and backward directions as shown by arrows θ about a center O2 of the turning shaft 54a, and the turning shaft 54a slides in the axial direction (Z direction) in synchronization with the turning operation so as to perform regular winding. The fed conductive wire 20 leads from the base-end side of the arm portion 54b of the flyer 54 through the inside of the arm portion 54b to the distal end part thereof.

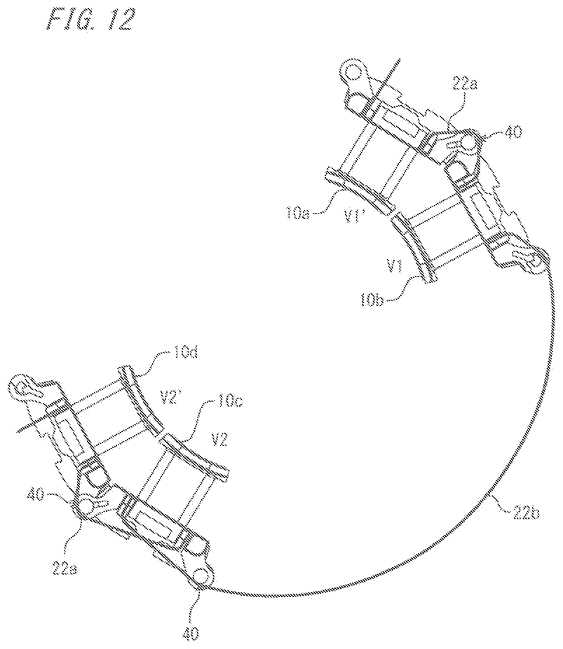

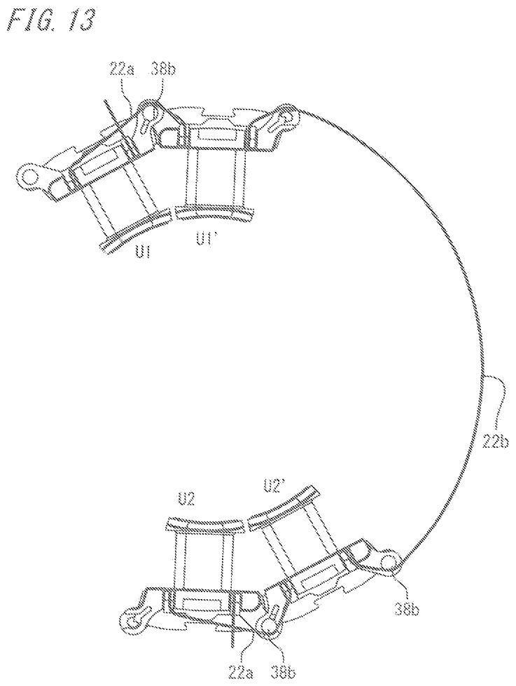

FIG. 12 illustrates a state in which the conductive wire 20 is wound continuously over four magnetic-pole pieces 10 corresponding to one phase (here, V phase) of the three-phase AC, and FIG. 13 illustrates a state in which the conductive wire 20 is wound continuously over four magnetic-pole pieces 10 corresponding to each (here, U phase as an example) of the other two phases of the three-phase AC. Parts of the conductive wire 20 that are wound around the tooth portions 12 are not shown.

As is found from comparison between FIG. 12 and FIG. 13, in the cases of U phase and W phase, the winding direction of the conductive wire 20 and the positions of the winding start part and the winding finish part are opposite to those in the case of V phase. Conversely, FIG. 12 may be applied to U phase and W phase and FIG. 13 may be applied to V phase. Also in this case, a stator having 10 poles and 12 teeth can be formed.

Next, with reference to FIG. 11 and FIG. 12, work (hereinafter, referred to as winding work) for winding the conductive wire 20 around each tooth portion of the total of four magnetic-pole pieces 10 composed of sets of two magnetic-pole pieces corresponding to one phase (here, V phase), and work (hereinafter, referred to as jumper wire work) for leading the winding finish part of the conductive wire 20 to the next magnetic-pole piece without cutting the winding finish part after the winding work, using the automatic winding machine 50, will be described.

Here, work in which a combination of the winding work and the jumper wire work is repeatedly performed is referred to as wiring work.

Here, for convenience of description, the magnetic-pole pieces are individually assigned with 10a, 10b, 10c, 10d, so as to discriminate the magnetic-pole pieces 10.

First, two sets, i.e., a set of two magnetic-pole pieces 10a, 10b and a set of two magnetic-pole pieces 10c, 10d are arranged at positions point-symmetric with each other across the center O1 of the retention jig 52. At this time, the adjacent magnetic-pole pieces 10a and 10b and the adjacent magnetic-pole pieces 10c and 10d are respectively connected to each other by snap-fit connection of the insulators 25, as described above.

Next, the set of two adjacent magnetic-pole pieces 10a, 10b and the set of two adjacent magnetic-pole pieces 10c, 10d are fixed by, for example, inserting the attachment pins of the retention jig 52 into the attachment grooves 13 formed at the back yoke portions 11, so that the tooth portions 12 are located on the outer side of the disk-shaped retention jig 52. Thus, the set of two adjacent magnetic-pole pieces 10a, 10b and the set of two adjacent magnetic-pole pieces 10c, 10d are respectively arranged to have V shapes such that the circumferential-direction separation distance between the tooth portions 12 of each set is expanded.

Then, the retention jig 52 is rotated to move one magnetic-pole piece 10a to a position opposed to the turning shaft 54a of the flyer 54. Subsequently, a terminal part of the conductive wire 20 extending from the distal end of the arm portion 54b of the flyer 54 is fixed to the winding-start-wire fixation pin 53 provided to the retention jig 52, or the like, and then the conductive wire 20 is led along the winding release groove 36 of the insulator 25. Then, the flyer 54 is turned (here, turned rightward as seen from the back yoke portion 11 side), and in synchronization therewith, the turning shaft is slid along the axial direction (Z direction), to wind the conductive wire 20 around the tooth portion 12 of the magnetic-pole piece 10a (hereinafter, referred to as winding work 1).

At this time, the winding work is performed with the arrangement positions of the magnetic-pole pieces set such that, of the set of two magnetic-pole pieces 10a, 10b, the other magnetic-pole piece 10b for which the winding work of the conductive wire 20 is not performed, and the other set of two magnetic-pole pieces 10c, 10d, are always located on the outer side (locations denoted by P2, P3, P4 in FIG. 11) relative to a rotation plane Q of the turning distal end of the flyer 54. In this way, when the conductive wire 20 is wound around one magnetic-pole piece 10a, the flyer 54 can be assuredly prevented from interfering with the other magnetic-pole pieces 10b, 10c, 10d.

Next, the retention jig 52 is rotated to move the other magnetic-pole piece 10b to the position opposed to the turning shaft 54a of the flyer 54. At this time, the winding finish part of the conductive wire 20 wound around the preceding magnetic-pole piece 10a is used as the jumper wire 22a without being cut, and is passed through the winding release groove 36 of the insulator 25. Then, the conductive wire 20 is led along the winding release groove 36 of the magnetic-pole piece 10b which is the next winding work target (hereinafter, the above work is referred to as jumper wire work 1).

Subsequently, the conductive wire 20 is wound around the tooth portion 12 of the magnetic-pole piece 10b in a direction (in this example, left-turn as seen from the back yoke portion 11 side) opposite to the direction of winding around the preceding magnetic-pole piece 10a (hereinafter, the above work is referred to as winding work 2).

At this time, the winding work is performed with the arrangement positions of the magnetic-pole pieces set such that the magnetic-pole pieces 10a, 10c, 10d other than the magnetic-pole piece 10b which is the winding work target of the conductive wire 20 are always located on the outer side relative to the rotation plane Q of the turning distal end of the flyer 54, whereby the flyer 54 can be assuredly prevented from interfering with the other magnetic-pole pieces 10a, 10c, 10d.

Next, the retention jig 52 is rotated to move the magnetic-pole piece 10c to the position opposed to the turning shaft 54a of the flyer 54. At this time, the winding finish part of the conductive wire 20 wound around the preceding magnetic-pole piece 10b is passed through the winding release groove 36 without being cut. Further, the conductive wire 20 over a predetermined length that can reach the magnetic-pole piece 10c which is the next winding work target is ensured as the jumper wire 22b, and then the conductive wire 20 is led along the winding release groove 36 of the magnetic-pole piece 10c which is the winding work target (hereinafter, the above work is referred to as jumper wire work 2).

Next, the conductive wire 20 is wound in the same direction as the preceding magnetic-pole piece 10b (left-turn as seen from the back yoke portion 11 side) (hereinafter, the above work is referred to as winding work 3).

Also in this case, the winding work is performed such that the magnetic-pole pieces 10d, 10a, 10b other than the magnetic-pole piece 10c which is the winding work target of the conductive wire 20 are always located on the outer side relative to the rotation plane Q of the turning distal end of the flyer 54, whereby the flyer 54 can be assuredly prevented from interfering with the other magnetic-pole pieces 10d, 10a, 10b.

Finally, the retention jig 52 is rotated to move the magnetic-pole piece 10d to the position opposed to the turning shaft 54a of the flyer 54. At this time, the winding finish part of the conductive wire 20 wound around the preceding magnetic-pole piece 10c is used as the jumper wire 22a without being cut, and is passed through the winding release groove of the insulator 25. Then, the conductive wire 20 is led along the winding release groove 36 of the magnetic-pole piece 10d which is the next winding work target (hereinafter, the above work is referred to as jumper wire work 3).

Subsequently, the conductive wire 20 is wound around the tooth portion 12 of the magnetic-pole piece 10d in a direction (in this example, right-turn as seen from the back yoke portion 11 side) opposite to the direction of winding around the preceding magnetic-pole piece 10c (hereinafter, the above work is referred to as winding work 4).

Also in this case, the winding work is performed such that the magnetic-pole pieces 10c, 10a, 10b other than the magnetic-pole piece 10d which is the winding work target of the conductive wire 20 are always located on the outer side relative to the rotation plane Q of the turning distal end of the flyer 54, whereby the flyer 54 can be assuredly prevented from interfering with the other magnetic-pole pieces 10c, 10a, 10b.

After the wiring work (winding work and jumper wire work) is performed for the total of four magnetic-pole pieces 10a, 10b, 10c, 10d composed of sets of two magnetic-pole pieces as described above, the magnetic-pole pieces 10a, 10b, 10c, 10d are detached from the retention jig 52. Then, as shown in FIG. 12, the tooth portions 12 of the set of two magnetic-pole pieces 10a, 10b and the set of two magnetic-pole pieces 10c, 10d are returned to the original arc shapes from the reversely warped V shapes. Thus, a state in which the conductive wire 20 is wound continuously over the four magnetic-pole pieces 10a, 10b, 10c, 10d corresponding to V phase, is obtained.

Of the four magnetic-pole pieces 10a, 10b, 10c, 10d, at least two magnetic-pole pieces may be continuously wound with the conductive wire 20 via the jumper wire 22, and a part where there is no jumper wire 22 may be compensated by wire connection. Desirably, all the magnetic-pole pieces 10a, 10b, 10c, 10d for each phase are continuously wound with the conductive wire 20 via the jumper wires 22, and this is preferable because the number of working steps and the number of components can be decreased.

Thereafter, the same work is performed also for the four magnetic-pole pieces 10 corresponding to each of U phase and W phase. Then, among the magnetic-pole pieces 10 including four magnetic-pole pieces for each phase, sets of two adjacent magnetic-pole pieces 10 are sequentially arranged with their phases alternated along the circumferential direction as shown in FIG. 1, so as to form an annular shape. Then, the adjacent end surfaces of the magnetic-pole pieces 10 are integrally connected by snap-fit connection using the insulators 25 (hereinafter, the above work is referred to as annular-shaping work). Subsequently, wire-connection processing is performed so as to make the wire-connection state shown in FIG. 3 and FIG. 4. Thereafter, processing such as performing molding with resin around the outer circumference of the magnetic-pole pieces 10 arranged in an annular shape, is performed, whereby the desired stator 2 for a three-phase DC brushless motor having 10 poles and 12 teeth is obtained.

As described above, under application of the automatic winding machine 50 as shown in FIG. 11, each magnetic-pole piece 10 attached to the rotational-positioning mechanism 51 can be sequentially moved to the position opposed to the turning shaft 54a of the flyer 54 merely by rotating the rotational-positioning mechanism 51. Then, after the magnetic-pole piece 10 is moved to the predetermined position, the conductive wire 20 can be wound by rotating the flyer 54 while the position of the magnetic-pole piece 10 remains fixed. That is, since the rotational-positioning mechanism 51 and the flyer 54 are separate and independent of each other, movement of the magnetic-pole piece 10 to the side where the conductive wire 20 is fed and winding of the conductive wire 20 can be performed at the same time by one mechanism. Thus, the apparatus configuration is simplified, failure is less likely to occur, and the apparatus can be manufactured at low cost.

In this configuration, the flyer 54 is rotated to perform winding of the conductive wire 20, and the magnetic-pole piece 10 is not rotated at high speed. Therefore, such a trouble that regularity of the wound conductive wire 20 is deteriorated due to occurrence of looseness or vibration during winding of the conductive wire 20, does not occur. Thus, the working time is shortened and the production amount per unit time can be increased.

As compared to a case where there are a larger number of magnetic-pole pieces 10 fixed to the retention jig 52, in a case where sets of two magnetic-pole pieces 10 are attached to the retention jig 52, the magnetic-pole pieces 10 are attached at desired intervals so as to have V shapes and then the rotational-positioning mechanism 51 is merely rotated, whereby each magnetic-pole piece 10 can be opposed to the flyer 54. Thus, it is possible to prevent occurrence of such a trouble that the angle between the adjacent magnetic-pole pieces 10 is narrowed so that winding of the conductive wire 20 is obstructed and the length of the jumper wire 22a cannot be freely set.

In forming the stator 2, in many cases, sets of two magnetic-pole pieces 10 are sequentially arranged with their phases alternated along the circumferential direction so as to form an annular shape. In such cases, the length of the jumper wire 22b making connection between the respective sets of two magnetic-pole pieces 10 is great. However, merely by rotating the rotational-positioning mechanism 51, each magnetic-pole piece 10 can be sequentially located at the location where the winding work is performed. Therefore, the length of the jumper wire 22b can be freely set.

At the time of making the winding 21, the flyer 54 can be prevented from interfering with the adjacent magnetic-pole piece 10, whereby regularity of the winding 21 can be enhanced. Also, the jumper wire 22b can be led to the magnetic-pole piece 10 present at a distant position, whereby productivity can be enhanced.

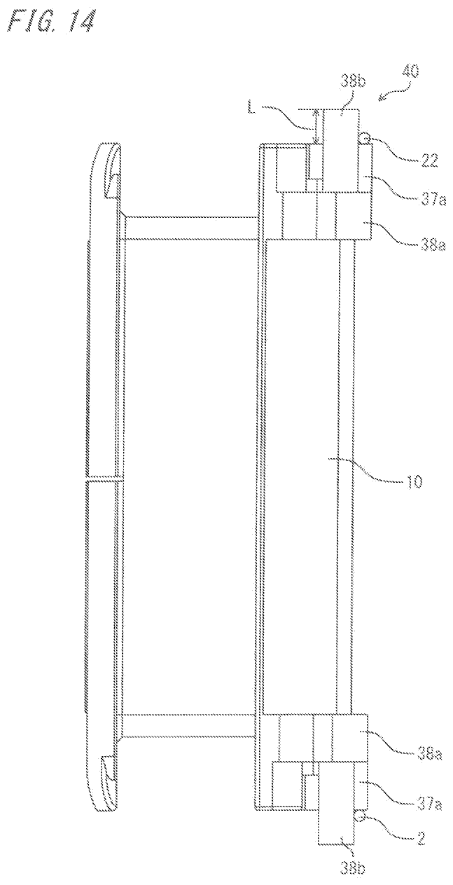

FIG. 14 is a schematic side view showing arrangement when the jumper wire is provided in a state in which the adjacent magnetic-pole pieces are connected by snap-fit connection of the insulators, as seen in the circumferential direction. Here, the winding is not shown.

The pillar portion 38b of the insulator 25 is set to have such a length as to protrude by a dimension L in the axial direction relative to the opened-ring portion 37a fitted therewith. Therefore, in the wiring work of the conductive wire 20 for the magnetic-pole pieces 10 using the automatic winding machine 50, the jumper wire 22 can be easily deformed by bending, winding, or the like with the jumper wire 22 caught at the pillar portion 38b. In addition, by the axial-direction end surface of the opened-ring portion 37a of the snap-fit female portion 37, the jumper wire 22 can be prevented from becoming excessively close to the magnetic-pole piece 10 on a route from the winding release groove 36 to the winding portion 28, whereby a necessary insulation distance can be easily ensured. Thus, the pillar portion 38b and the opened-ring portion 37a serve as a jumper-wire-caught portion 40 at which the jumper wire 22 is caught.

The outer periphery of the pillar portion 38b serving as the rotation center about which the adjacent magnetic-pole pieces 10 rotate, is located on the radially outer side relative to the adjacent magnetic-pole pieces 10. Therefore, after winding around the tooth portions 12, when the tooth portions 12 are returned from the reverse warped state to the original state in which they form an arc shape, the jumper wire 22 is less subjected to tension or looseness and is prevented from moving. Thus, it is not necessary to perform work for adjusting the position of the jumper wire 22 again in a post-process.

The above applies to both of the pair of insulators 25 attached from both axial-direction ends of the magnetic-pole piece 10. The jumper wire 22 can be placed at one or both of the pair of insulators 25 at both axial-direction ends. Therefore, it is possible to easily prevent contact between the jumper wires having a great potential difference between different phases.

Generally, spaces outward of both axial-direction ends of the magnetic-pole piece 10 are not used, but these spaces can be effectively used. In a case of making insulation between a plurality of magnetic-pole pieces 10 by an alternative component such as a printed board without using the above spaces, the material cost for the alternative component and a space therefor are needed. However, effectively using the above spaces can contribute to size reduction of the rotary electric machine, and the like.

In the example shown in FIG. 11 and FIG. 12 above, the jumper wire 22b making connection between the respective sets of two adjacent magnetic-pole pieces 10 is led along an outer periphery of the stator. However, there are no particular constraints on how to lead the jumper wire 22b, as long as the jumper wire 22b can be prevented from interfering with each magnetic-pole piece 10 when all the magnetic-pole pieces 10 are connected in an annular shape. For example, the jumper wire 22b can be located on the radially inner side or the radially outer side of each of the magnetic-pole pieces 10 arranged in an annular shape.

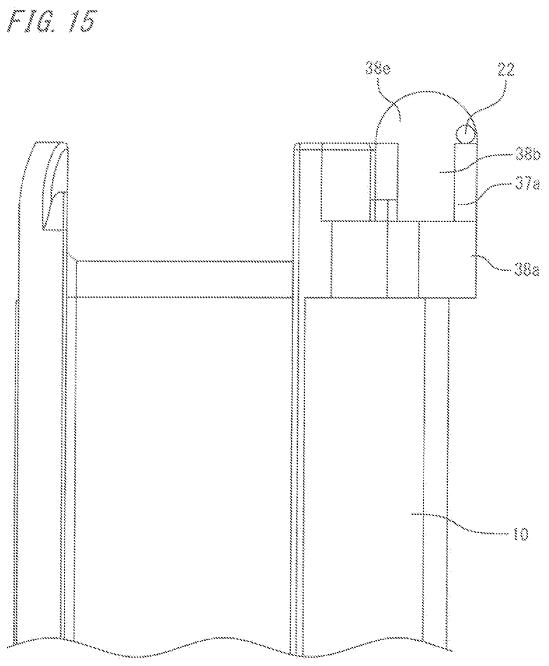

FIG. 15 is a schematic half sectional view showing an example for assuredly fixing the jumper wire to the magnetic-pole piece 10 in the stator of embodiment 1.

Here, as shown in FIG. 14, after the jumper wire 22 is provided in a state in which the adjacent magnetic-pole pieces 10 are connected by snap-fit connection of the insulators 25, an axial-direction end of the pillar portion 38b is welded so as to enclose the jumper wire 22, thus forming a welded portion 38e. The insulator 25 is made of thermoplastic resin. Therefore, even if the insulator 25 is formed by injection molding, the welded portion 38e can be easily formed by applying heat later. Hereinafter, the above work is referred to as welding work.

In this case, the welding work may be performed before the magnetic-pole pieces 10 are returned to the annular shape or after they are returned to the annular shape. In the former case, the jumper wire 22 can be prevented from moving when the magnetic-pole pieces 10 are returned to the annular shape. In the latter case, the welding strength can be made greater than in the former case, movements of the magnetic-pole pieces 10 relative to each other are restricted, and work for returning the magnetic-pole pieces 10 into the annular shape and handling work for the stator 2 after the annular shaping are facilitated.

The welded portion 38e is formed in at least one location on the jumper wire 22 for each phase, and it is desirable that the welded portions 38e are formed in all locations. In this case, in the subsequent molding step, resin can be prevented from contacting with the jumper wire 22, thus having an advantage that the jumper wire 22 can be easily located at a desired position.

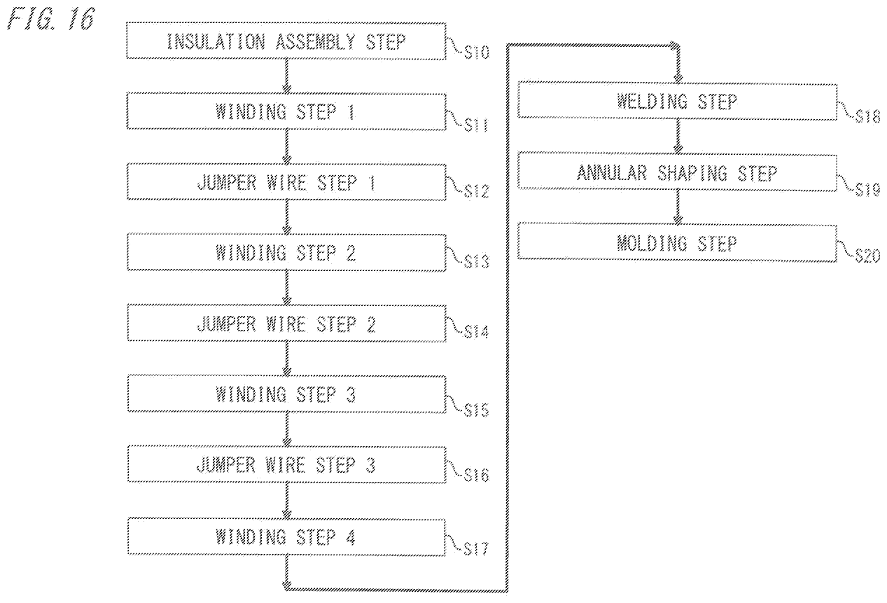

FIG. 16 is a flowchart showing a manufacturing method for the stator of the rotary electric machine of embodiment 1.

First, in an insulation assembly step of step S10, the above insulation assembly work is performed to attach the insulators 25 to each magnetic-pole piece 10. Next, each pair of adjacent magnetic-pole pieces 10 are connected by snap-fit connection, and with the two connected magnetic-pole pieces 10 regarded as a set, two sets thereof (four in total) are set as one of U, V, and W phases. In the insulation assembly step, instead of attaching a pair of insulators 25 to the magnetic-pole piece 10, the magnetic-pole piece 10 may be put into a molding machine and directly covered by resin, to perform integral molding.

After the insulation assembly step of step S10 is finished, the process proceeds to a wiring step of performing the above wiring work (winding work and jumper wire work for the conductive wire 20) for the four magnetic-pole pieces 10 corresponding to one phase.

Specifically, the following steps are performed.

First, in a winding step 1 of step S11, the above winding work 1 is performed to wind a conductive wire in a concentrated manner around one magnetic-pole piece 10a with the insulators 25 interposed.

Next, in a jumper wire step 1 of step S12, the above jumper wire work 1 is performed to form a jumper wire continuously to the magnetic-pole piece 10b which is the next winding target without cutting the conductive wire.

Next, in a winding step 2 of step S13, the above winding work 2 is performed to wind the conductive wire in a concentrated manner around one magnetic-pole piece 10b with the insulators 25 interposed.

Next, in a jumper wire step 2 of step S14, the above jumper wire work 2 is performed to form a jumper wire continuously to the magnetic-pole piece 10c which is a distant winding target without cutting the conductive wire.

Next, in a winding step 3 of step S15, the above winding work 3 is performed to wind the conductive wire in a concentrated manner around one magnetic-pole piece 10c with the insulators 25 interposed.

Next, in a jumper wire step 3 of step S16, the above jumper wire work 3 is performed to form a jumper wire continuously to the magnetic-pole piece 10d which is the next winding target without cutting the conductive wire 20.

Next, in a winding step 4 of step S17, the above winding work 4 is performed to wind the conductive wire 20 in a concentrated manner around one magnetic-pole piece 10d with the insulators 25 interposed.

Next, in a welding step of step S18, the above welding work is performed to form the welded portion 38e so that the jumper wire is covered at the connection part of snap-fit connection of the insulators 25, as shown in FIG. 15. Thus, it is possible to prevent the jumper wire from moving even when the orientations of the magnetic-pole pieces 10 are changed.

After the wiring step (winding steps 1 to 4 and jumper wire steps 1 to 3) for the four magnetic-pole pieces 10 corresponding to one of U, V, and W phases is completed, the wiring step (winding steps 1 to 4 and jumper wire steps 1 to 3) is repeatedly performed in the same manner also for the four magnetic-pole pieces 10 corresponding to each of the other remaining phases.

After the wiring step for the four magnetic-pole pieces 10 is completed for all the phases, in an annular shaping step of step S19, all the magnetic-pole pieces 10 wound as shown in FIG. 1 are sequentially arranged with their phases alternated along the circumferential direction so as to form an annular shape. Then, the adjacent end surfaces of the magnetic-pole pieces 10 are integrally connected by snap-fit connection using the insulators 25. Thus, the above annular-shaping work is performed.

Finally, in a molding step of step S20, molding work is performed to mold, with the resin 5, the entire stator 2 including the annularly arranged magnetic-pole pieces 10, the conductive wires 20, the opened-ring portions 37a, the pillar portions 38b, and the jumper-wire-caught portions 40 of the insulators 25, and the like.

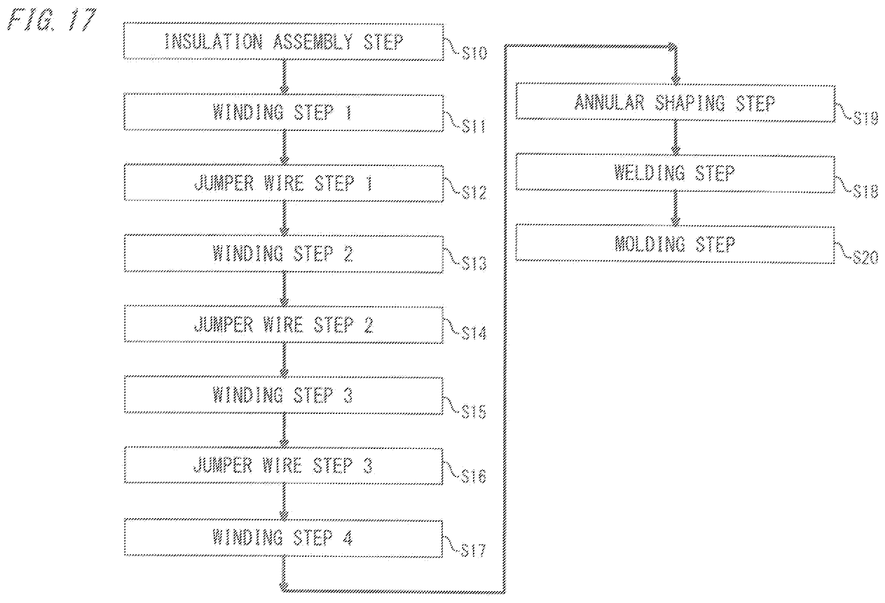

FIG. 17 shows a modification of the stator manufacturing method shown in FIG. 16.

In this stator manufacturing method, the welding step in step S18 is performed after the annular shaping step in step S19. Thus, movement of the magnetic-pole pieces 10 at the time of annular shaping can be prevented and a shape as the stator 2 can be easily maintained. Therefore, the magnetic-pole pieces 10 are prevented from moving around during handling until the molding step of performing molding with resin subsequently, and the shape remains maintained at the time of insertion into a molding mold, whereby insertion is facilitated.

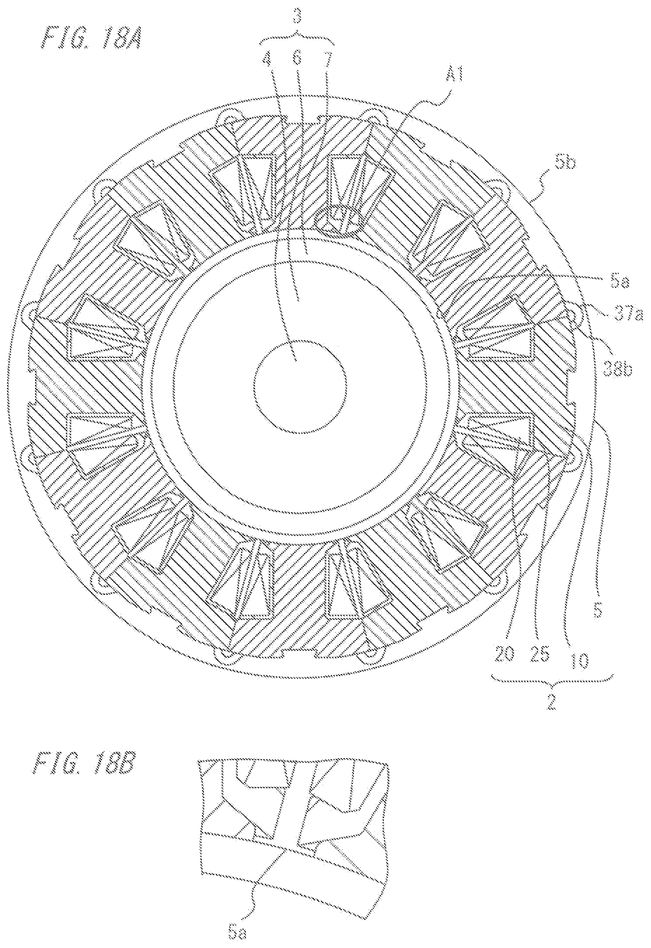

After the stator manufacturing process shown in FIG. 16 or FIG. 17, a step of placing a rotor rotatably and coaxially on the radially inner side of the stator 2 is performed, thus obtaining a desired rotary electric machine having a small size and high performance at low cost. FIG. 18A is a schematic sectional view of the rotary electric machine obtained as described above, and FIG. 18B is an enlarged view of part A1 in FIG. 18A.

In this rotary electric machine 1, a rotor 3 is rotatably and coaxially provided on the radially inner side of the stator 2 having the configuration shown in FIG. 1, and the outer circumference of the stator 2 is molded with the resin 5. The rotor 3 is composed of, from the radially inner side, a rotation output shaft 4, a rotor core 6 fitted to the rotation output shaft 4, and a permanent magnet 7 arranged around the outer circumference of the rotor core 6. The permanent magnet 7 is magnetized to form ten poles.

Here, the permanent magnet 7 has a ring shape. However, without limitation thereto, for example, a plurality of divisional magnets may be used. The rotor 3 has a surface permanent magnet (SPM) configuration. However, without limitation thereto, an interior permanent magnet (IPM) configuration may be adopted, for example.

Here, the entire stator 2 including the conductive wires 20, the opened-ring portions 37a, the pillar portions 38b, and the jumper-wire-caught portions 40 of the insulators 25, and the like is molded with the resin 5. That is, the resin 5 molded around the stator 2 has an inner circumferential surface 5a formed at the position of the inner-circumferential outline extending in the circumferential direction along the inner circumferential surfaces of the magnetic-pole pieces 10, and has an outer circumferential surface 5b formed at a position covering the entirety including the opened-ring portions 37a, the pillar portions 38b, and the jumper-wire-caught portions 40 of the insulators 25, which protrude radially outward of the magnetic-pole pieces 10.

With this configuration, even if the pillar portions 38b serving as the rotation centers for the insulators 25 are located on the radially outer side of the magnetic-pole pieces 10, the magnetic-pole pieces 10 can be easily fixed. That is, if a tubular metal ring is provided around the outer circumference of the magnetic-pole pieces 10 by press-fit, adhesion, or the like, the tubular metal ring interferes with the connection parts by snap-fit connection of the insulators 25, which protrude radially outward of the magnetic-pole pieces 10. However, as in embodiment 1, by performing molding with the resin 5, the above interference can be avoided and the divisional magnetic-pole pieces 10 are fixed in an annular shape. In addition, even if oil or the like adheres to the outer surface of the stator 2, damage to the conductive wires 20 and the magnetic-pole pieces 10 can be prevented.

In embodiment 1, a case of configuring the stator 2 of the rotary electric machine 1 for a three-phase DC brushless motor having 10 poles and 12 teeth has been assumed. Therefore, as the adjacent magnetic-pole pieces 10, two magnetic-pole pieces 10 are wound continuously. However, without limitation thereto, even for three or more adjacent magnetic-pole pieces 10, as long as they are wound continuously via the jumper wire 22, it is possible to locate the jumper wire 22 near the rotation center by using the insulators 25 of the present disclosure.

As described above, according to embodiment 1, the insulators 25 that are one kind and have the same shape are used, these insulators 25 are attached to the magnetic-pole pieces 10, and the adjacent magnetic-pole pieces 10 are connected by snap-fit connection. Thus, it is possible to obtain the rotary electric machine 1 having the high-performance stator 2 without increasing the number of used components. In addition, manufacturing can be performed without unnecessarily increasing manufacturing steps, and therefore the manufacturing cost can be reduced.

### Embodiment 2

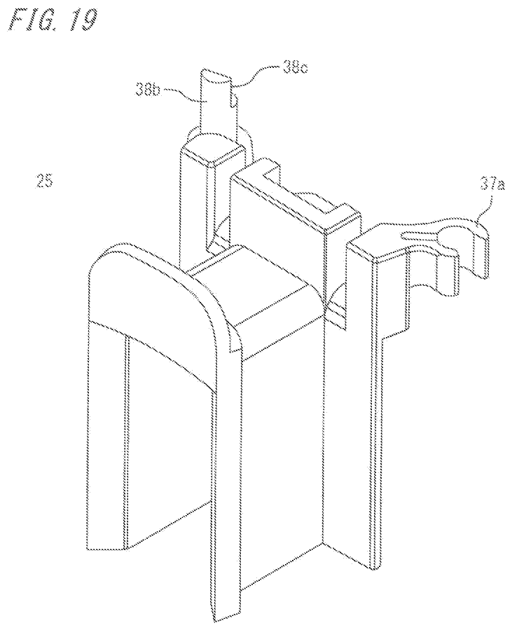

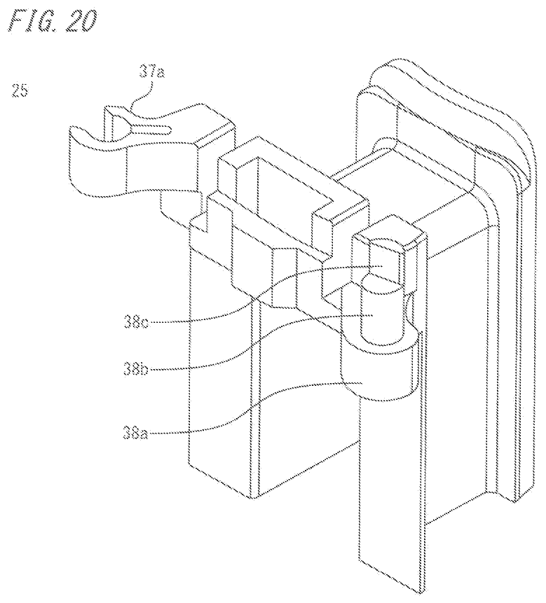

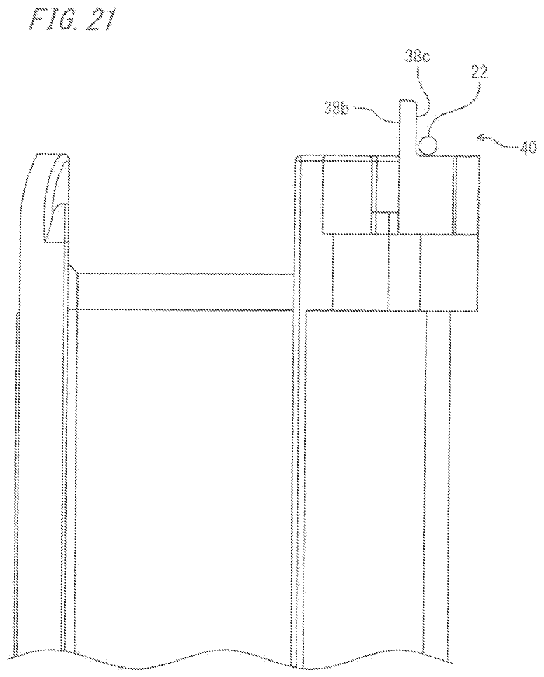

FIG. 19 is a perspective view of one insulator to be attached to a magnetic-pole piece as seen from the radially inner side in embodiment 2, FIG. 20 is a perspective view of the same insulator as seen from the radially outer side, and FIG. 21 is a schematic side view showing arrangement when a jumper wire is provided in a state in which the insulators are attached to the adjacent magnetic-pole pieces, as seen in the circumferential direction. Parts corresponding to those in FIG. 7 and FIG. 8 are denoted by the same reference characters.

A feature of embodiment 2 is that a cutout 38c is provided at a part of the pillar portion 38b of the insulator 25 and the jumper wire 22 is arranged so as to pass through the cutout 38c. In this case, the cutout 38c is formed such that a surface thereof along the axial direction faces radially outward of the magnetic-pole piece 10, i.e., toward the radially outer side opposite to the tooth portion 12. Thus, the cutout 38c serves as the jumper-wire-caught portion 40 at which the jumper wire 22 is caught.

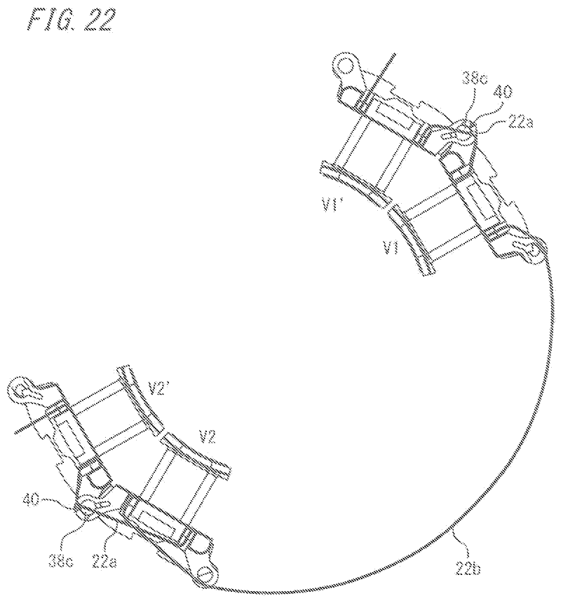

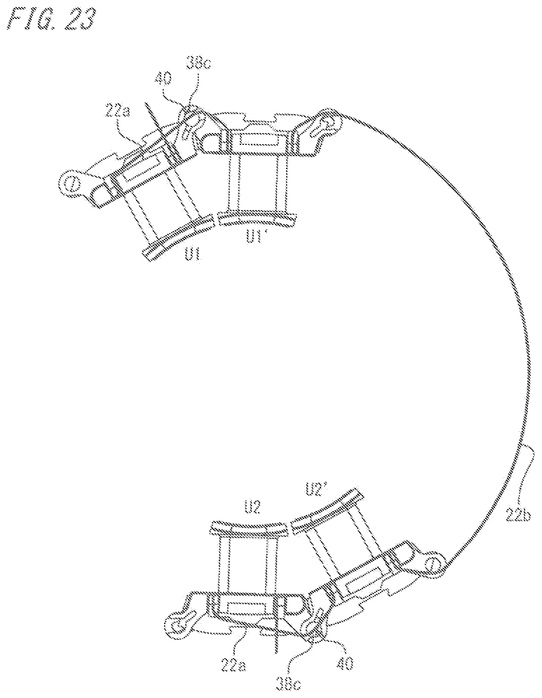

FIG. 22 illustrates a state in which the conductive wire 20 is wound continuously over the four magnetic-pole pieces 10 corresponding to one phase (here, V phase) of the three-phase AC, and FIG. 23 illustrates a state in which the conductive wire 20 is wound continuously over the four magnetic-pole pieces 10 corresponding to each (here, U phase as an example) of the other two phases of the three-phase AC. Parts of the conductive wire 20 that are wound around the tooth portions 12 are not shown.

Between the adjacent magnetic-pole pieces 10, the jumper wire 22a is arranged so as to pass through the cutout 38c provided to the pillar portion 38b. In this case, the center of the pillar portion 38b is the rotation center of snap-fit connection, and therefore the jumper wire 22a is located at such a position as to pass near the rotation center. Thus, movement of the jumper wire 22a is prevented as described above.

In FIG. 22 and FIG. 23, for the magnetic-pole pieces 10 distant from each other, the continuously led jumper wire 22b is not arranged at the cutout 38c provided to the pillar portion 38b. However, without limitation thereto, also the jumper wire 22b may be similarly arranged at the cutout 38c by being deformed by bending, winding, or the like. Such a configuration can prevent movement of the jumper wire 22b, whereby the position thereof can be prevented from being displaced when the magnetic-pole pieces 10 are detached from the automatic winding machine 50 and when they are formed into an annular shape.

As described above, in embodiment 2, the cutout 38c is provided at a part of the pillar portion 38b of the insulator 25 that serves as the rotation center of snap-fit connection, and the jumper wire 22 is arranged so as to pass through the cutout 38c near the rotation center, thus providing an effect of more preventing movement of the jumper wire 22. In addition, since the cutout 38c is provided to the pillar portion 38b, an effect of reducing the amount of used resin as compared to embodiment 1 is provided.

### Embodiment 3

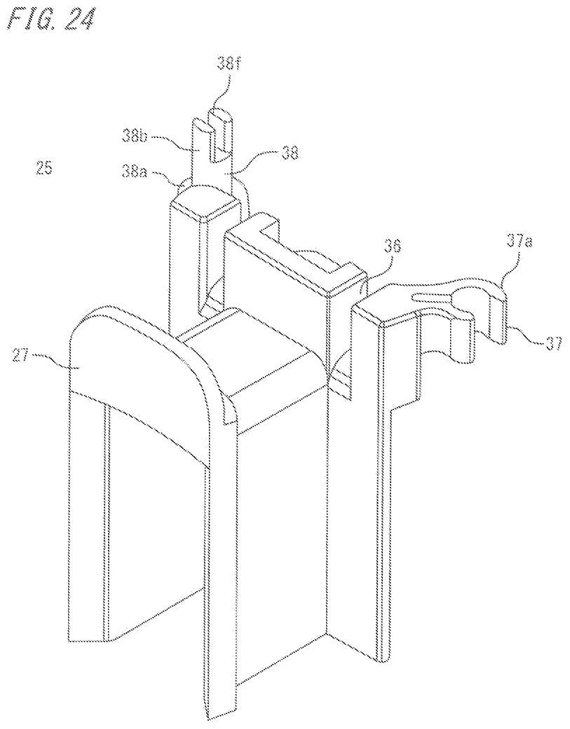

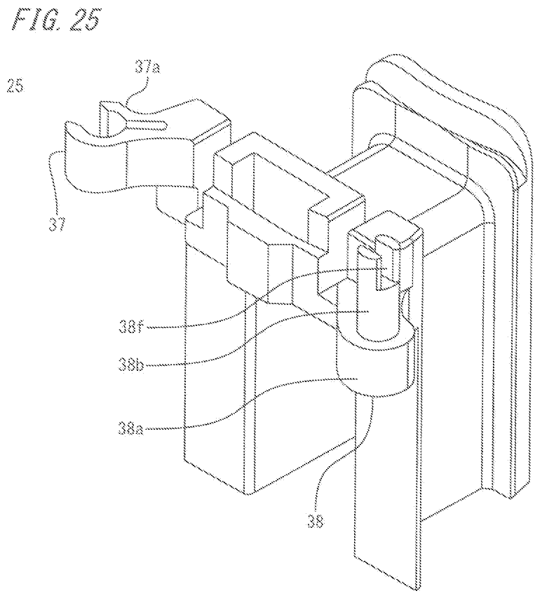

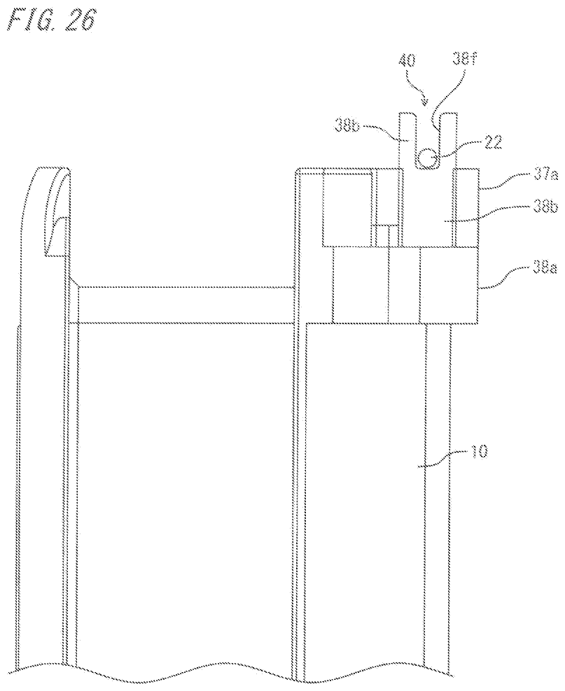

FIG. 24 is a perspective view of one insulator to be attached to a magnetic-pole piece as seen from the radially inner side in embodiment 3, FIG. 25 is a perspective view of the same insulator as seen from the radially outer side, and FIG. 26 is a schematic side view showing arrangement when a jumper wire is provided in a state in which the insulators are attached to the adjacent magnetic-pole pieces, as seen in the circumferential direction.

A feature of embodiment 3 is that a slit 38f is provided at a part of the pillar portion 38b of the insulator 25, and the slit 38f serves as the jumper-wire-caught portion 40 at which the jumper wire 22 is caught. In this case, the slit 38f is formed so as to pass the rotation center of the pillar portion 38b serving as the rotation center of snap-fit connection and extend along the axial direction from an end surface on the side opposite to the base portion 38a in the axial direction. The jumper wire 22 is arranged so as to pass through the inside of the slit 38f. In this case, the slit 38f has walls extending in the axial direction, on the radially inner side and the radially outer side, and thus can even more prevent movement of the jumper wire 22. Thus, it is not necessary to perform work such as arranging the position of the jumper wire 22 to a desired position again in a post-process.

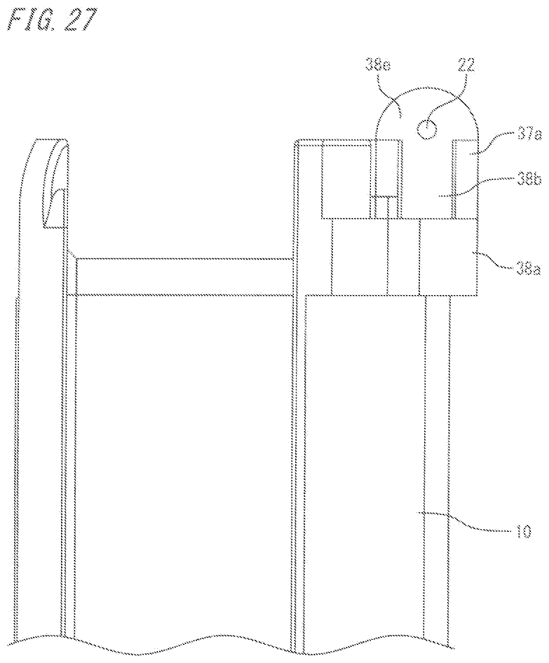

As shown in FIG. 27, in a state in which the jumper wire 22 is passed through the slit 38f, the axial-direction end of the pillar portion 38b may be welded to form the welded portion 38e. After the wiring step, the welding step may be performed before the annular shaping step or after the annular shaping step. In the former case, even when the magnetic-pole pieces 10 are rotated in the subsequent annular shaping step, movement of the jumper wire 22 can be restricted. In the latter case, at the connection parts of snap-fit connection, including those where the jumper wires 22 are not located, a fixation force between the pillar portion 38b and the opened-ring portion 37a can be increased, whereby both portions 38b and 37a can be restricted from rotating relative to each other. That is, movements of the magnetic-pole pieces 10 relative to each other can be restricted, and the magnetic-pole piece 10 can be prevented from moving around during handling.

Modifications of the above embodiments 1, 2, and 3 will be described below.

Modification 1

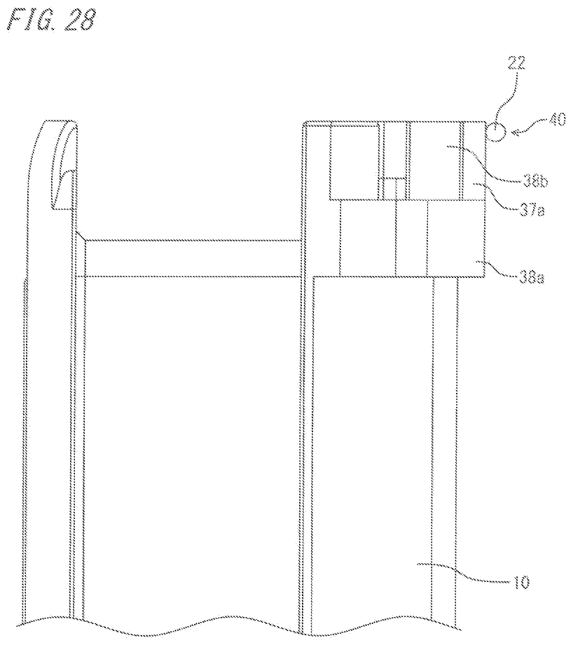

In FIG. 28, a difference from embodiment 1 is that the axial-direction length of the pillar portion 38b of the snap-fit male portion 38 is small and is set to be the same as the axial-direction thickness of the opened-ring portion 37a of the snap-fit female portion 37. Thus, the axial-direction end surface of the pillar portion 38b is flush with the axial-direction end surface of the opened-ring portion 37a. Therefore, the jumper wire 22 is arranged on the radially outer side of the opened-ring portion 37a by being deformed by bending, winding, or the like. Thus, a part of the radially-outer circumferential side of the opened-ring portion 37a serves as the jumper-wire-caught portion 40 at which the jumper wire 22 is caught. With this configuration, the used material amount for the insulator 25 can be reduced as compared to embodiments 1 and 2.

Modification 2

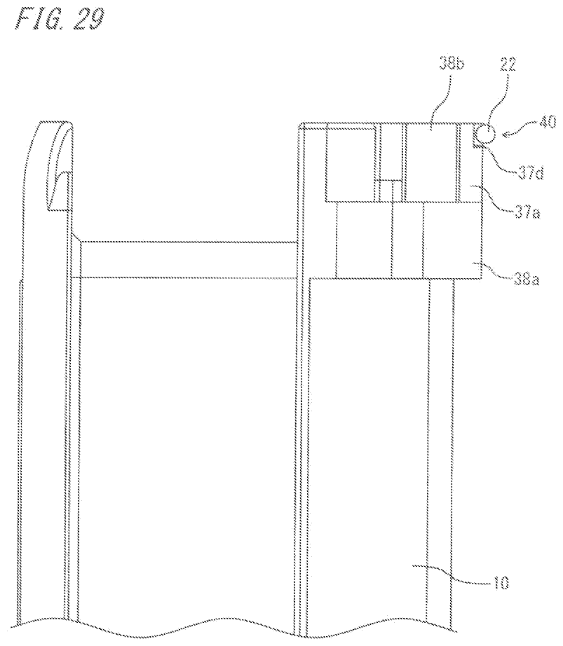

In FIG. 29, as in the case of FIG. 28, the axial-direction end surface of the pillar portion 38b is flush with the axial-direction end surface of the opened-ring portion 37a, but a difference from FIG. 28 is that, at the axial-direction end of the opened-ring portion 37a of the snap-fit female portion 37, a part on the radially-outer circumferential side is cut out to form a cutout 37d, and the jumper wire 22 is arranged at the cutout 37d by being deformed by bending, winding, or the like.

Thus, the cutout 37d serves as the jumper-wire-caught portion 40 at which the jumper wire 22 is caught.

Thus, as compared to the configuration in FIG. 28, axial-direction movement of the jumper wire 22 can be easily restricted by the axial-direction end surface of the cutout 37d. In addition, at the time of arranging the jumper wire 22 by the automatic winding machine 50, even if the conductive wire 20 is moved due to vibration in high-speed operation, the conductive wire 20 can be easily positioned by the cutout 37d, whereby productivity can be enhanced.

Modification 3

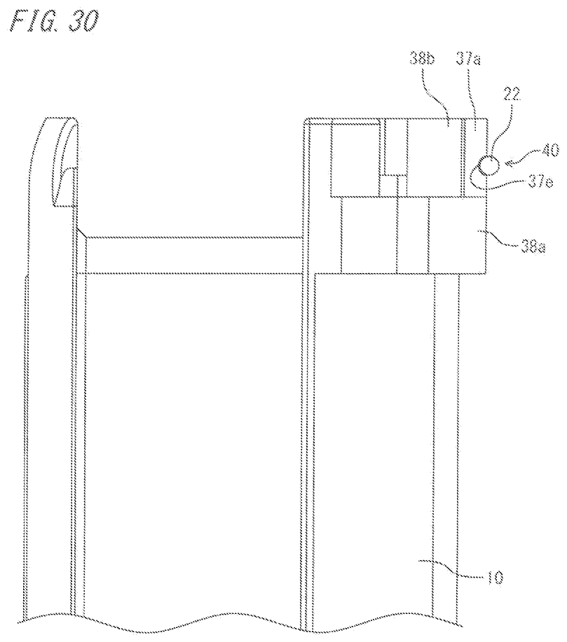

In FIG. 30, a difference from the insulator 25 in FIG. 29 is that, at an axial-direction intermediate portion of the opened-ring portion 37a of the snap-fit female portion 37, a part on the radially-outer circumferential side is cut out to form a C-shaped groove 37e, and the jumper wire 22 is arranged so as to pass through the inside of the groove 37e by being deformed by bending, winding, or the like. Thus, the groove 37e serves as the jumper-wire-caught portion 40 at which the jumper wire 22 is caught.

In this case, as compared to the configuration in FIG. 29, the groove 37e has walls on the upper and lower sides in the axial direction, whereby movement of the jumper wire 22 can be more restricted. Thus, it is not necessary to perform work such as arranging the position of the jumper wire 22 to a desired position again in a post-process. In addition, at the time of arranging the jumper wire 22 by the automatic winding machine 50, even if the conductive wire 20 is moved due to vibration in high-speed operation, the wire can be easily positioned by the groove 37e, whereby productivity can be enhanced.

Modification 4

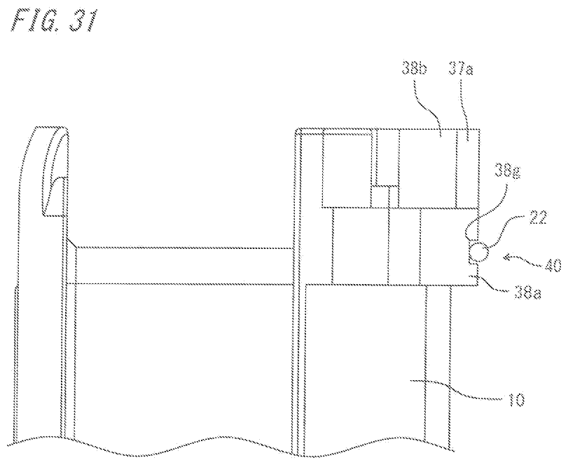

In FIG. 31, a part on the radially-outer circumferential side of the base portion 38a of the snap-fit male portion 38 of the insulator 25 is cut out to form a C-shaped groove 38g, and the jumper wire 22 is arranged so as to pass through the inside of the groove 38g by being deformed by bending, winding, or the like. Thus, the groove 38g serves as the jumper-wire-caught portion 40 at which the jumper wire 22 is caught.

In this case, as in the configuration in FIG. 30, the groove 38g has walls on the upper and lower sides in the axial direction, whereby movement of the jumper wire 22 can be more restricted. Further, as compared to modifications 1 to 3 (FIG. 28 to FIG. 30), the jumper wire 22 can be arranged at an axial-direction position closer to the magnetic-pole piece 10. Thus, the length of the jumper wire 22 can be shortened, and the amount of used wire material can be reduced. In addition, at the time of arranging the jumper wire 22 by the automatic winding machine 50, even if the wire is moved due to vibration in high-speed operation, the wire can be easily positioned by the groove 38g, whereby productivity can be enhanced.

Modification 5

In embodiment 1 (FIGS. 18A and 18B), the entire stator 2 including the conductive wires 20, the opened-ring portions 37a, the pillar portions 38b, and the jumper-wire-caught portions 40 of the insulators 25, and the like is molded with the resin 5.

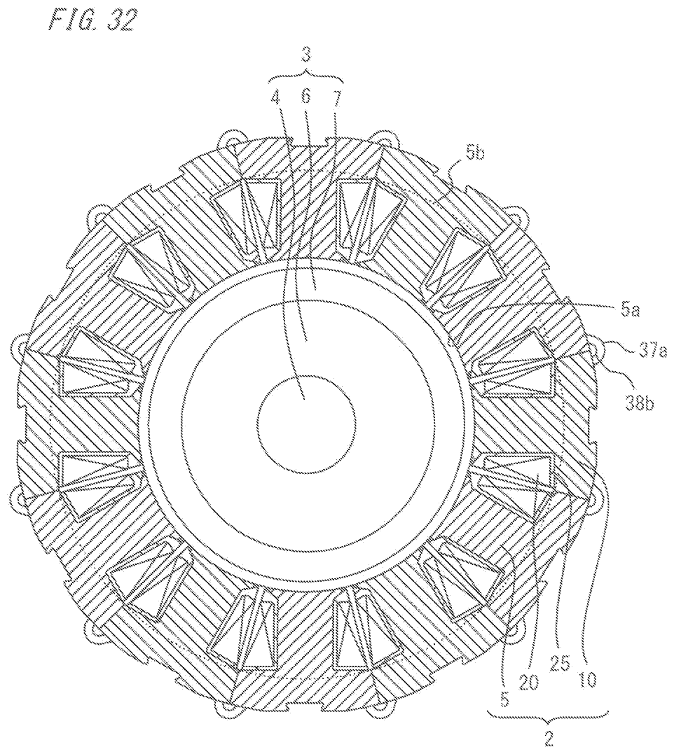

In contrast, in the modification shown in FIG. 32, the resin 5 molded around the stator 2 has the inner circumferential surface 5a formed at the position of the inner-circumferential outline extending in the circumferential direction along the inner circumferential surfaces of the magnetic-pole pieces 10, but has the outer circumferential surface 5b (indicated by a broken line in the drawing) formed on the inner side relative to the position of the outer-circumferential outline extending in the circumferential direction along the outer circumferential surfaces of the magnetic-pole pieces 10, unlike the case of embodiment 1 (FIGS. 18A and 18B). Thus, in this configuration, the opened-ring portions 37a, the pillar portions 38b, and the jumper-wire-caught portions 40 of the insulators 25, and the like are not molded with the resin 5.

As described above, the outer circumferential surface 5b of the molded resin 5 is formed on the inner side relative to the position of the outer circumferential outline extending in the circumferential direction along the outer circumferential surfaces of the magnetic-pole pieces 10, whereby, while the divisional magnetic-pole pieces 10 are kept in an annularly fixed state, the usage amount of the molded resin 5 can be reduced, so that the weight and the material cost can be reduced.

Modification 6

In the above modification 5 (FIG. 32), the outer circumferential surface 5b of the molded resin 5 is formed on the inner side relative to the position of the outer circumferential outline extending in the circumferential direction along the outer circumferential surfaces of the magnetic-pole pieces 10, and the opened-ring portions 37a, the pillar portions 38b, and the jumper-wire-caught portions 40 of the insulators 25, and the like are not molded with the resin 5.

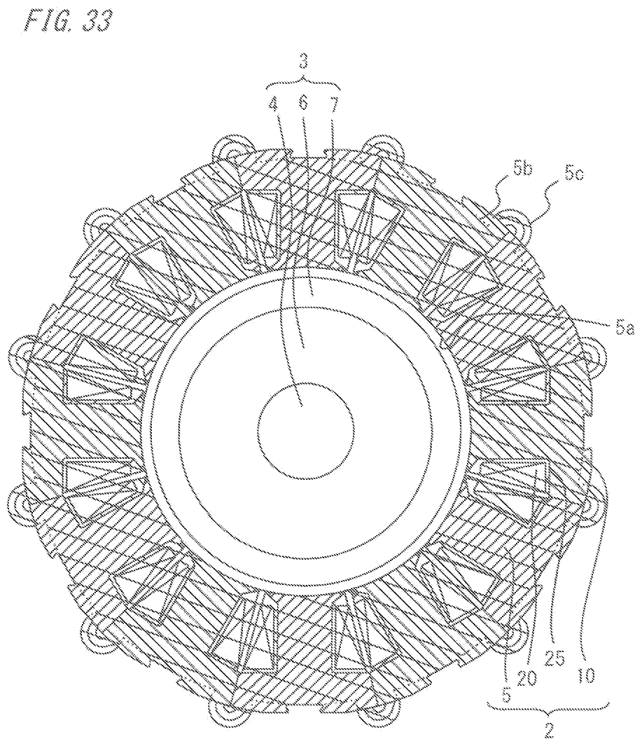

In contrast, in the modification shown in FIG. 33, the outer circumferential surface 5b (indicated by a broken line in the drawing) is formed slightly on the inner side relative to the position of the outer circumferential outline extending in the circumferential direction along the outer circumferential surfaces of the magnetic-pole pieces 10. However, unlike the case of modification 5 (FIG. 32), the opened-ring portions 37a, the pillar portions 38b, and the jumper-wire-caught portions 40 of the insulators 25, which protrude radially outward of the magnetic-pole pieces 10, are locally molded with the resin 5c. Thus, the jumper wires (not shown) are also molded.

As described above, the snap-fit female portions 37, the snap-fit male portions 38, and the jumper-wire-caught portions 40 of the insulators 25, which are connection parts between the magnetic-pole pieces 10, are molded with the resin 5, whereby rigidity of the stator 2 of the rotary electric machine 1 can be increased and vibration can be suppressed. In addition, even if oil or the like adheres to the outer surface of the stator 2, damage to the snap-fit female portions 37, the snap-fit male portions 38, and the jumper-wire-caught portions 40 of the insulators 25, and the like can be prevented. Further, except for the parts where the opened-ring portions 37a, the pillar portions 38b, and the jumper-wire-caught portions 40 of the insulators 25, which protrude radially outward of the magnetic-pole pieces 10, are locally molded with the resin 5c, the outer circumferential surface 5b (indicated by the broken line in the drawing) is formed slightly on the inner side relative to the position of the outer circumferential outline extending in the circumferential direction along the outer circumferential surfaces of the magnetic-pole pieces 10. Thus, as compared to the case of embodiment 1 (FIGS. 18A and 18B), the usage amount of the molded resin 5 can be reduced, so that the weight and the material cost can be reduced.

Modification 7

In the modification of embodiment 3 shown in FIG. 27, the slit 38f is provided at a part of the pillar portion 38b of the insulator 25, and in a state in which the jumper wire 22 is passed through the slit 38f, the axial-direction end of the pillar portion 38b is welded to form the welded portion 38e.

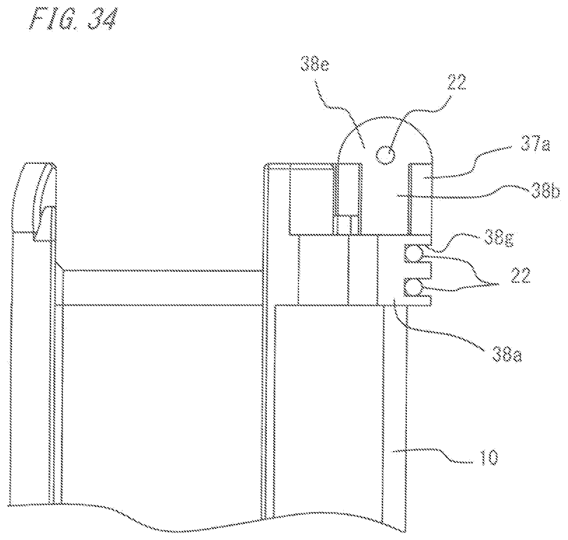

In contrast, in the modification shown in FIG. 34, in addition to the configuration shown in FIG. 27, parts on the radially-outer circumferential side of the base portion 38a of the snap-fit male portion 38 of the insulator 25 are cut out to form grooves 38g having a C shape in a cross-section, at two locations on the upper and lower sides along the axial direction. The jumper wires 22 are arranged so as to pass through the insides of the grooves 38g by being deformed by bending, winding, or the like.

In this case, the jumper wire 22 passing through the part where the pillar portion 38b is welded to form the welded portion 38e, is a jumper wire led between the adjacently located magnetic-pole pieces 10 and corresponding to one phase (e.g., V phase), and the jumper wire arranged at each groove 38g is a jumper wire corresponding to another different phase (e.g., U or W phase).

With this configuration, movement of the jumper wire 22 at the part where the pillar portion 38b is welded can be restricted even when the magnetic-pole pieces 10 are rotated in the annular shaping step, and in addition, since the jumper wires 22 for the other phases pass through the insides of the grooves 38g, the jumper wires 22 for different phases having a great potential difference can be prevented from accidentally contacting with each other.

Modification 8

In modification 7 (FIG. 34), the slit 38f is provided at a part of the pillar portion 38b of the insulator 25, and in a state in which the jumper wire 22 is passed through the slit 38f, the pillar portion 38b is welded. Also, parts on the radially-outer circumferential side of the base portion 38a of the snap-fit male portion 38 are cut out to form the grooves 38g at two locations, and the jumper wires 22 are passed through the insides of the grooves 38g.

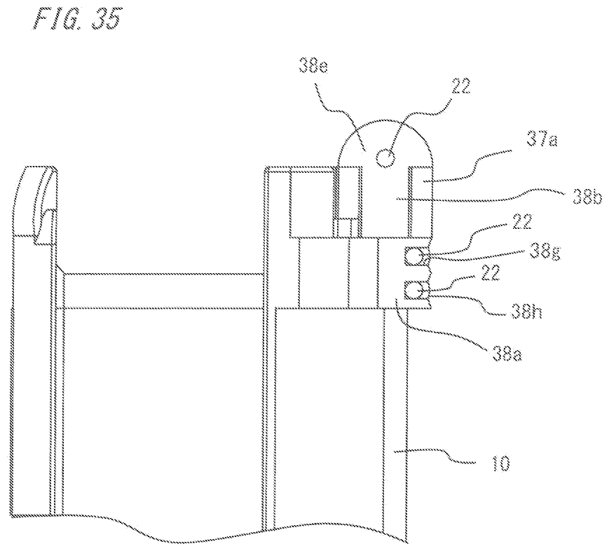

In contrast, in the modification shown in FIG. 35, in addition to the configuration shown in FIG. 34, after the jumper wires 22 are passed through the insides of the grooves 38g, these parts are welded to form welded portions 38h and fix the jumper wires 22. Also in this case, the jumper wires 22 arranged at the pillar portion 38b and inside each groove 38g are jumper wires 22 for different phases.

With this configuration, for example, after the annular shaping step, the jumper wires 22 are arranged inside the grooves 38g, and then these parts are welded to fix the jumper wires 22. Thus, movement of each jumper wire 22 can be restricted and the jumper wires 22 for different phases having a great potential difference can be assuredly prevented from accidentally contacting with each other.

Although the disclosure is described above in terms of various exemplary embodiments and modifications, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 rotary electric machine
2 stator
3 rotor
5 resin
10, 10a, 10b, 10c, 10d magnetic-pole piece
11 back yoke portion
12 tooth portion
20 conductive wire
21 winding
22, 22a, 22b jumper wire
25 insulator
37 snap-fit female portion
37a opened-ring portion
37b opening
37d cutout
37e groove
38 snap-fit male portion
38a base portion
38b pillar portion
38c cutout
38e, 38h welded portion
38f slit
38g groove
40 jumper-wire-caught portion
50 automatic winding machine
51 rotational-positioning mechanism
54 flyer

1. A stator comprising a plurality of magnetic-pole pieces in each of which a tooth portion is integrally formed so as to protrude from an arc-shaped back yoke portion inward in a radial direction, wherein
a pair of insulators made of resin are attached to each magnetic-pole piece, in an axial direction perpendicular to the radial direction,
the magnetic-pole pieces with the insulators attached thereto are arranged in an annular shape in a state in which a conductive wire is continuously wound via a jumper wire making connection between the magnetic-pole pieces,
each insulator has a snap-fit female portion at one end in a circumferential direction of an axial-direction end thereof and has a snap-fit male portion at another end,
the snap-fit female portion has an opened-ring portion having an opening that opens in a direction perpendicular to the axial direction,
the snap-fit male portion has a pillar portion extending in the axial direction from a base portion protruding in the circumferential direction and the radial direction,
the adjacent magnetic-pole pieces in the annular-shape arrangement are connected swingably relative to each other via snap-fit connection made by fitting of the pillar portion to the opened-ring portion, and
a jumper-wire-caught portion at which the jumper wire is caught is provided at least in one of the open-ring portion and the pillar portion.

2. The stator according to claim 1, wherein
the opened-ring portion is provided such that a gap corresponding to an axial-direction thickness of the base portion is formed between the opened-ring portion and the magnetic-pole piece in the axial direction, and in the snap-fit connected state, the base portion is held in the gap so that axial-direction displacement is restricted.

3. The stator according to claim 1, wherein
the jumper-wire-caught portion is at least one of a part of an outer circumferential surface of the pillar portion, a cutout formed at the outer circumferential surface of the pillar portion, a slit formed in the pillar portion, a groove formed at an outer circumferential surface of the base portion, a part of an outer circumferential surface of the opened-ring portion, a cutout formed at the outer circumferential surface of the opened-ring portion, or a groove formed at the outer circumferential surface of the opened-ring portion.

4. The stator according to claim 1, wherein
parts of all the magnetic-pole pieces and at least a part of the jumper-wire-caught portion are molded with resin.

5. The stator according to claim 1, wherein
at least one of the jumper-wire-caught portions at which the jumper wires are caught is welded so as to cover a part of the jumper wire.

6. A rotary electric machine comprising:
the stator according to claim 1; and
a rotor provided rotatably and coaxially on an inner circumferential surface side of the stator.

7. A stator manufacturing method for the stator according to claim 1, comprising:
an insulation assembly step of attaching the insulators to each magnetic-pole piece;
a wiring step of repeating a winding step of winding, in a concentrated manner, the conductive wire around one magnetic-pole piece having undergone the insulation assembly step, and a jumper wire step of, after the winding step, leading the conductive wire as the jumper wire to the magnetic-pole piece that is a next winding target without cutting the conductive wire; and
an annular shaping step of, after winding of the conductive wire is completed for all the magnetic-pole pieces in the wiring step, arranging the magnetic-pole pieces in the annular shape and connecting all the adjacent magnetic-pole pieces by the snap-fit connection of the insulators.

8. The stator manufacturing method according to claim 7, wherein
in the wiring step,
an apparatus is applied, the apparatus including a rotational-positioning mechanism having a rotation axis in a stacking direction of the magnetic-pole piece, and a conductive-wire feeding and winding flyer which feeds the conductive wire while turning about a rotation axis set in a direction perpendicular to the rotation axis of the rotational-positioning mechanism, and
a total of four magnetic-pole pieces including first and second magnetic-pole pieces snap-fit connected as a set of two adjacent magnetic-pole pieces and third and fourth magnetic-pole pieces snap-fit connected as a set of two adjacent magnetic-pole pieces, are attached to the rotational-positioning mechanism, such that each set of two adjacent magnetic-pole pieces are arranged with the tooth portions distant from each other in the circumferential direction so as to have a V shape,
thereafter, the wiring step includes
a winding step 1 of winding the conductive wire around the tooth portion of the first magnetic-pole piece by the flyer,
a jumper wire step 1 of rotating the rotational-positioning mechanism so that the second magnetic-pole piece is opposed to the flyer, and arranging the jumper wire, without cutting the conductive wire,
a winding step 2 of winding the conductive wire around the tooth portion of the second magnetic-pole piece by the flyer,
a jumper wire step 2 of rotating the rotational-positioning mechanism so that the third magnetic-pole piece is opposed to the flyer, and arranging the jumper wire, without cutting the conductive wire,
a winding step 3 of winding the conductive wire around the tooth portion of the third magnetic-pole piece by the flyer,
a jumper wire step 3 of rotating the rotational-positioning mechanism so that the fourth magnetic-pole piece is opposed to the flyer, and arranging the jumper wire, without cutting the conductive wire, and
a winding step 4 of winding the conductive wire around the tooth portion of the fourth magnetic-pole piece by the flyer, and
the annular shaping step includes a step of deforming each set of two adjacent magnetic-pole pieces from the V shape into an arc shape, and then, with the four magnetic-pole pieces regarded as a set, the sets thereof are arranged and assembled in the annular shape such that the number of the sets is a multiple of 3.

9. The stator manufacturing method according to claim 7, further comprising a welding step of welding the jumper-wire-caught portion, after the wiring step and before the annular shaping step.

10. The stator manufacturing method according to claim 7, further comprising a welding step of welding the jumper-wire-caught portion, after the wiring step and the annular shaping step are performed.

11. A rotary electric machine manufacturing method comprising a step of providing a rotor rotatably and coaxially on an inner circumferential surface side of the stator, after a process of the stator manufacturing method according to claim 7.

12. The stator according to claim 3, wherein
the jumper-wire-caught portion is the cutout formed at the outer circumferential surface of the pillar portion,
the cutout passes through a rotation center of the snap-fit connection, and
the jumper wire passes through the rotation center at the cutout.

13. The stator according to claim 12, wherein
a surface of the cutout along the axial direction faces toward the radially outer side opposite to the tooth portion.

14. The stator according to claim 3, wherein
the jumper-wire-caught portion is the slit formed in the pillar portion,
the slit passes through the rotation center of the snap-fit connection and extends along the axial direction from an end surface on the side opposite to the base portion in the axial direction, and
the jumper wire is arranged to pass through the inside of the slit.

15. The stator according to claim 2, wherein
the jumper-wire-caught portion is at least one of a part of an outer circumferential surface of the pillar portion, a cutout formed at the outer circumferential surface of the pillar portion, a slit formed in the pillar portion, a groove formed at an outer circumferential surface of the base portion, a part of an outer circumferential surface of the opened-ring portion, a cutout formed at the outer circumferential surface of the opened-ring portion, or a groove formed at the outer circumferential surface of the opened-ring portion.

16. The stator according to claim 15, wherein
the jumper-wire-caught portion is the cutout formed at the outer circumferential surface of the pillar portion,
the cutout passes through a rotation center of the snap-fit connection, and
the jumper wire passes through the rotation center at the cutout.

17. The stator according to claim 16, wherein
a surface of the cutout along the axial direction faces toward the radially outer side opposite to the tooth portion.

18. The stator according to claim 15, wherein
the jumper-wire-caught portion is the slit formed in the pillar portion,
the slit passes through the rotation center of the snap-fit connection and extends along the axial direction from an end surface on the side opposite to the base portion in the axial direction, and
the jumper wire is arranged to pass through the inside of the slit.

19. The stator according to claim 2, wherein
parts of all the magnetic-pole pieces and at least a part of the jumper-wire-caught portion are molded with resin.

20. The stator according to claim 3, wherein
parts of all the magnetic-pole pieces and at least a part of the jumper-wire-caught portion are molded with resin.
